(19) United States
(12) Patent Application Publication
(10) Pub. No.: US 2024/0301653 A1
(43) Pub. Date: Sep. 12, 2024

(54) POWER SYSTEM ASSEMBLY FOR A POWER MACHINE

(71) Applicant: Doosan Bobcat North America, Inc., West Fargo, ND (US)

(72) Inventors: Michael Schmidt, Bismarck, ND (US); Brent Durkin, Bismarck, ND (US)

(21) Appl. No.: 18/601,391

(22) Filed: Mar. 11, 2024

Related U.S. Application Data
(60) Provisional application No. 63/489,456, filed on Mar. 10, 2023.

(51) Int. Cl. E02F 9/08

(52) U.S. Cl. CPC E02F 9/0866

(57) ABSTRACT

A power transmission assembly for a power machine can include a motor sub-assembly that can include a bearing carrier, a reduction assembly, and an electric motor. An outboard side of the bearing carrier can be fixedly attached to a first side of a frame of the power machine to operably transmit rotational power to at least one tractive element of the power machine. An outboard side of the reduction assembly can be fixedly attached to an inboard side of the bearing carrier. An inboard side of the electric motor can be fixedly attached to the outboard side of the reduction assembly, and can operably transmit the rotational power to the bearing carrier via the reduction assembly. The electric motor can be disposed laterally between the reduction assembly and the first side of the frame.

### CROSS-REFERENCE TO RELATED APPLICATIONS

This application claims priority to U.S. provisional patent application No. 63/489,456, filed Mar. 10, 2023, the entirety of which is incorporated herein by reference.

### BACKGROUND

This disclosure is directed toward power machines. More particularly, the present disclosure is directed to motor assemblies for power machines. Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders, excavators, utility vehicles, tractors including compact tractors, and trenchers, to name a few examples. Other types of power machines can include mini-loaders (e.g., mini track loaders), and mowers.

Different types of power machines, including skid-steer loaders, can include a power system powered by a power source to operate one or more components of the power machine. For example, some power machines include one or more motors that are arranged within a frame of the power machine and that are powered by a power source to operate two or more tractive elements of the power machine.

The discussion above is merely provided for general background information and is not intended to be used as an aid in determining the scope of the claimed subject matter.

### SUMMARY

Examples according to this disclosure can provide a power system assembly, including motor sub-assemblies, for power machines. For example, some implementations disclosed herein can provide a power system assembly include an electrical power source and one or more electric motor assemblies that can be arranged within a frame of the power machine and powered by the electrical power source (e.g., to provide tractive power).

Some examples of the disclosure provide a power transmission assembly for a power machine that defines a lateral direction. The power transmission assembly can include a first motor sub-assembly that can include a bearing carrier, a reduction assembly, and an electric motor. An outboard side of the bearing carrier can be configured to be fixedly attached to a first side of a frame of the power machine to operably transmit rotational power to at least one tractive element of the power machine. The reduction assembly can have an outboard side fixedly attached to an inboard side of the bearing carrier. The electric motor can have an inboard side fixedly attached to the outboard side of the reduction assembly and can operably transmit the rotational power to the bearing carrier via the reduction assembly. The electric motor can be disposed laterally between the reduction assembly and the first side of the frame.

In some examples, with the first motor sub-assembly secured to the frame of the power machine, the electric motor can be supported by the reduction assembly with a drive axis of the electric motor rearward of a power transmission axis of the bearing carrier. In some such examples, with the first motor sub-assembly secured to the frame, the drive axis can be one or more of horizontally aligned with the power transmission axis along a front to back direction of the power machine or parallel with the power transmission axis.

In some examples, the reduction assembly can be a gearbox providing a speed reduction for power transmission between the electric motor and the bearing carrier.

In some examples, the outboard side of the bearing carrier of the first motor sub-assembly can be secured to a first lateral side of the frame and the power transmission assembly can further include a second motor sub-assembly. The second motor sub-assembly can include a second bearing carrier having an inboard side, and an outboard side that can be fixedly attached to a second lateral side of the frame to operably transmit rotational power to at least one second tractive element of the power machine, a second reduction assembly having an outboard side that can be fixedly attached to the inboard side of the second bearing carrier, and a second electric motor having an inboard side that can be fixedly attached to the outboard side of the second reduction assembly and can be configured to operably transmit the rotational power to the second bearing carrier via the second reduction assembly, with the second electric motor disposed laterally between the second reduction assembly and the second lateral side of the frame. In some such examples, the first motor sub-assembly can be secured to a first chain case on the first lateral side of the frame to power first and second axles of the power machine and the second motor sub-assembly can be secured to a second chain case on the second lateral side of the frame to power third and fourth axles of the power machine.

In some examples, in an installed configuration on the power machine, the electric motor can be cantilevered from the reduction assembly and the reduction assembly can be cantilevered from the bearing carrier. In some such examples, the bearing carrier can define a first lateral width that can correspond to a first lateral spacing of the reduction assembly from the frame in the installed configuration, and the electric motor can define a second lateral width that can be smaller than the first lateral spacing, so that the electric motor can be spaced laterally from the frame in the installed configuration.

Some examples of the disclosure provide a power machine that can include a frame, a power source supported by the frame, a first axle assembly arranged on a first side of the frame, and a first motor sub-assembly arranged along the first side of the frame to power the first axle assembly. The first motor sub-assembly can include a first bearing carrier, a first reduction assembly, and a first electric motor. The first bearing carrier can be fixedly attached to and operably supported by the first side of the frame and operably engaged with the first axle assembly. The first reduction assembly can be operably supported by the first bearing carrier relative to the frame, with the first reduction assembly inboard of the first bearing carrier and operably engaged with the first bearing carrier to power the first axle assembly via the first bearing carrier. The first electric motor can be operably supported by the first reduction assembly relative to the first bearing carrier, to be thereby supported by the first bearing carrier relative to the frame, with the first electric motor being outboard of the first reduction assembly, inboard of the first axle assembly, and operably engaged with the first reduction assembly to power the first axle assembly via the first reduction assembly and the first bearing carrier, using power from the power source.

In some examples, the power machine can further include a second axle assembly that can be arranged on a second side of the frame that is laterally opposite the first side and a second motor sub-assembly that can be arranged along the second side of the frame to power the second axle assembly. The second motor sub-assembly can include a second bearing carrier that can be fixedly attached to the second side of the frame and operably engaged with the second axle assembly, a second reduction assembly that can be operably supported by the second bearing carrier relative to the frame, with the second reduction assembly inboard of the second bearing carrier and operably engaged with the second bearing carrier to power the second axle assembly via the second bearing carrier, and a second electric motor that can be operably supported by the second reduction assembly relative to the second bearing carrier, to be thereby supported by the second bearing carrier relative to the frame. The second electric motor can be outboard of the second reduction assembly, inboard of the second axle assembly, and operably engaged with the second reduction assembly to power the second axle assembly via the second reduction assembly and second bearing carrier, using power from the power source.

In some such examples, a power transmission axis of the first bearing carrier can be aligned with a power transmission axis of the second bearing carrier, relative to a front to back direction of the power machine. In some such examples, a drive axis of the first electric motor can be aligned with a drive axis of the second electric motor along the front to back direction. In some such examples, the drive axis of the first electric motor can be horizontally aligned with the power transmission axis of the first bearing carrier, and the drive axis of the second electric motor can be horizontally aligned with the power transmission axis of the second bearing carrier. In other such examples, a drive axis of the first electric motor can be offset one of forward or rearward from a drive axis of the second electric motor, relative to a front to back direction of the power machine.

In some examples, the first electric motor can be one or more of operably supported relative to the frame only by the first bearing carrier, via the first reduction assembly, or operably supported relative to the frame only via the first reduction assembly.

In some examples, the first motor sub-assembly can be secured within a frame cavity having a cavity width in a lateral direction, and the first reduction assembly can be supported by the first bearing carrier to define an installed lateral width of the first motor sub-assembly that can be in a range between 40% and 48% of the cavity width, inclusive.

In some examples, the first axle assembly can include a first chain case that can power a forward ground engaging element and a rearward ground engaging element.

In some examples, the first electric motor can include a cooling loop, and a coolant inlet and a coolant outlet that are in communication with the cooling loop. The first motor sub-assembly can be secured to the frame so that the first reduction assembly supports the first electric motor with the coolant inlet and the coolant outlet one or more of opening rearwardly, relative to a front to back direction of the power machine, or being aligned below a top surface of the first reduction assembly.

Some examples of the disclosure provide a method of assembling a power machine. The method can include securing a first motor sub-assembly on a first lateral side of the power machine, to power one or more first tractive elements on the first lateral side. Securing the first motor sub-assembly on the first lateral side of the power machine can include securing a first bearing carrier to a first frame sidewall on the first lateral side of the power machine, securing a first gearbox to be cantilevered from the first bearing carrier with the first gearbox inboard of the first bearing carrier and the first frame sidewall, and securing a first electric motor to be cantilevered from the first gearbox with the first electric motor outboard of the first gearbox and inboard of the first frame sidewall.

In some examples, the method can further include securing a second motor sub-assembly on a second lateral side of the power machine, opposite the first lateral side, to power one or more second tractive elements, that can include securing a second bearing carrier to a second frame sidewall on the second lateral side of the power machine, and, after securing the first gearbox and the first electric motor on the first lateral side, securing a second gearbox to be cantilevered from the second bearing carrier with the second gearbox inboard of the second bearing carrier and the second frame sidewall, and securing a second electric motor to be cantilevered from the second gearbox with the second electric motor outboard of the second gearbox and inboard of the second frame sidewall.

Some examples of the disclosure provide a power transmission assembly for a power machine that can include a bearing carrier, a reduction assembly, and an electric motor. The bearing carrier can be attached at a first carrier side to a first lateral side of a frame of the power machine, with the bearing carrier operably engaged to transmit rotational power to at least one tractive element of the power machine. The reduction assembly can be coupled to a second carrier side of the bearing carrier that is opposite the first carrier side in a lateral direction, with a first side of the reduction assembly facing toward the first lateral side of the frame. The electric motor can be coupled to the first side of the reduction assembly to transmit power from the electric motor to the bearing carrier, with the electric motor disposed laterally between the first side of the reduction assembly and the first lateral side of the frame.

This Summary and the Abstract are provided to introduce a selection of concepts in a simplified form that are further described below in the Detailed Description. This Summary is not intended to identify key features or essential features of the claimed subject matter, nor are they intended to be used as an aid in determining the scope of the claimed subject matter.

### DRAWINGS

The following drawings are provided to help illustrate various features of non-limiting examples of the present disclosure and are not intended to limit the scope of the disclosure or exclude alternative implementations.

FIG. 1 is a block diagram illustrating functional systems of a representative power machine on which examples of the present disclosure can be advantageously practiced.

FIGS. 2 and 3 illustrate axonometric views of a representative power machine in the form of a skid-steer loader of the type on which the disclosed examples can be practiced.

FIG. 4 is a block diagram illustrating components of a power system of a power machine, such as the skid-steer loader illustrated in FIGS. 2 and 3.

FIGS. 5 and 6 are block diagrams illustrating components of an example power system of a power machine, which can be implemented for the skid-steer loader illustrated in FIGS. 2 and 3.

FIG. 7 is a top plan view of an example configuration of the power system of FIGS. 5 and 6 installed on a power machine frame, including example motor sub-assemblies.

FIG. 8 is a detailed view of area 8-8 of FIG. 7.

FIGS. 9 and 10 are top plan and axonometric views of the power system of FIG. 7, with a power source arranged on the frame.

FIGS. 11-13 are axonometric and top plan views of an example configuration for one of the motor sub-assemblies of the power system of FIG. 7, including an example reduction assembly.

FIGS. 14 and 15 are cross-sectional schematic views of a drive motor of the motor sub-assembly of FIGS. 11-13, taken along line 14-14 and line 15-15 of FIG. 11, respectively.

FIG. 16 is an axonometric view of the power system and frame of FIG. 7, with drive motors and reduction assemblies of the motor sub-assemblies removed.

FIG. 17 is a cross-sectional view of an example bearing carrier of the power system of FIG. 7, taken along line 17-17 of FIG. 16.

FIG. 18 is a perspective view of an example configuration of the frame of FIG. 7 with a sidewall of the frame and other components partly removed to show example chain-drive axle assemblies.

FIG. 19 is a side elevation detailed view of one of the chain-drive axle assemblies of FIG. 18.

FIGS. 20 and 21 are axonometric views of the power system and frame of FIG. 7, illustrating removal (or installation) of the motor sub-assemblies.

FIG. 22 is a cross-sectional partly schematic view of the power system and frame of FIG. 7 taken along line 22-22 of FIG. 21.

FIG. 23 is a partly schematic axonometric view of an example coolant system of the power system of FIG. 9.

FIGS. 24 and 25 are schematic representations of methods of assembling a power machine according to examples of the present disclosure.

### DETAILED DESCRIPTION

The concepts disclosed in this discussion are described and illustrated by referring to exemplary implementations of the disclosed technology. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Conventional power machines may be configured with a power system that includes a power source and one or more motor assemblies that are powered by the power source to operate tractive elements of the power machine. In particular, internal combustion engines are commonly utilized as the power source of power systems in conventional power machines. Such internal combustion engines are commonly arranged to leave ample space for the one or more motor assemblies to be arranged within the frame cavity, and to provide efficient power transmission over known transmission pathways. However, arrangements for power systems in conventional power machines may not be optimally suited for use with electrically powered power machines in general. In particular, conventional arrangements may not be readily adaptable for electrically powered machines, in power systems that use a rechargeable battery system in place of an internal combustion engine. These latter machines in particular may require significantly more or differently configured space for power sources within a frame cavity than conventional designs. Requirements concerning cooling, power transmission (e.g., for speed reduction), and other factors for electrically powered systems can also complicate power machine design relative to engine-driven power systems.

Examples of the present disclosure can address these problems, for example, by providing a power system with improved arrangements of motor assemblies. In particular, some example power systems can include powered drive actuators (e.g., electrical drive motors) that are located inboard of a frame or an axle assembly on an associated side of the power machine, and that are also located outboard of a reduction gearbox or other associated power-transmission assembly. In some such cases, the actuator can be supported relative to a power machine frame only (or primarily) by a gearbox or other speed reduction assembly, which may itself be supported relative to the power machine frame only (or primarily) by a bearing carrier. In addition to improved overall packaging, structural stability, and power transmission, some such arrangements can in particular provide improved availability of space for a rechargeable battery system and related components.

Further, examples of the present disclosure can provide motor assemblies, and particularly drive motor assemblies, that are more easily installed, removed, or otherwise serviced, as compared to conventional motor assemblies. For example, some aspects of the present disclosure can provide first and second motor sub-assemblies that are arranged within the frame cavity with a gap therebetween so that the first motor sub-assembly can be serviced (e.g., installed or disassembled) without requiring removal of the second motor sub-assembly.

In some arrangements, cantilevered support of drive motors or power reduction assemblies can in particular provide improved structural and operational characteristics for delivery of drive power. For example, some arrangements can include a drive motor that is cantilevered to extend outboard of a gearbox or other speed reduction assembly (e.g., with the gearbox inboard of an associated bearing carrier or chain drive). As another example, some arrangements can include an electric drive motor that is cantilevered from a reduction gearbox or otherwise supported by the frame via the gearbox or other assembly (e.g., with the gearbox cantilevered from a bearing carrier or axle assembly to support the drive motor).

In some arrangements, particular alignment of axes for power transmission (e.g., front-to-rear or horizontal alignment) can provide particular benefits for packaging or power transmission efficiency. For example, some motor sub-assemblies can include a power transmission axis between a drive motor and a gearbox that is offset from, but optimally aligned with, a power transmission axis between the gearbox and an axle assembly (e.g., via a single-axis bearing carrier). In particular, some sub-assemblies can include horizontally aligned power transmission axes (e.g., in combination with one or more aspects the inboard/outboard arrangements discussed above), although other configurations are also possible. In some examples, power transmission axes for motor sub-assemblies can be arranged to be aligned with each other laterally across a power machine (e.g., with a power transmission axes for a right-side drive motor sub-assembly being coaxial with power transmission axes for a left-side drive motor sub-assembly).

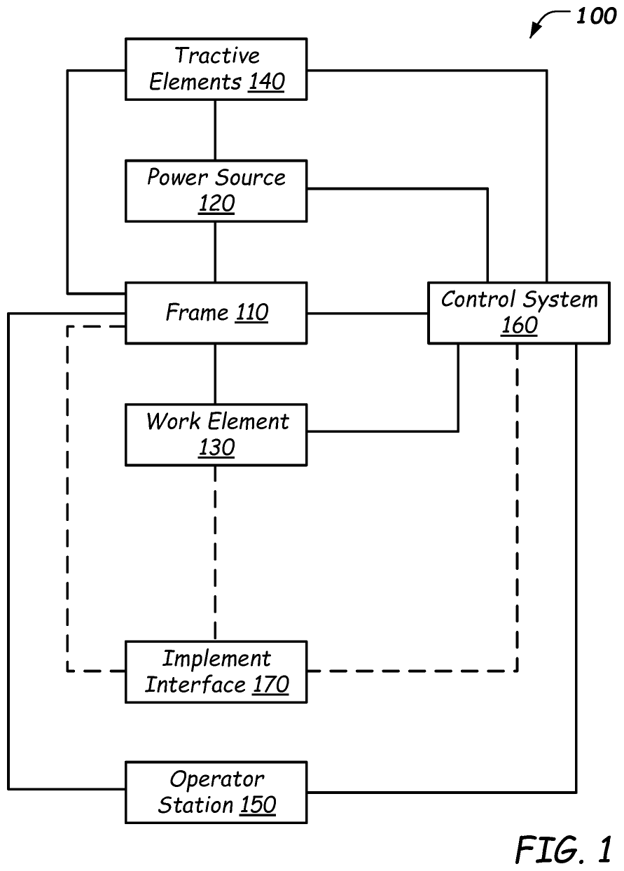

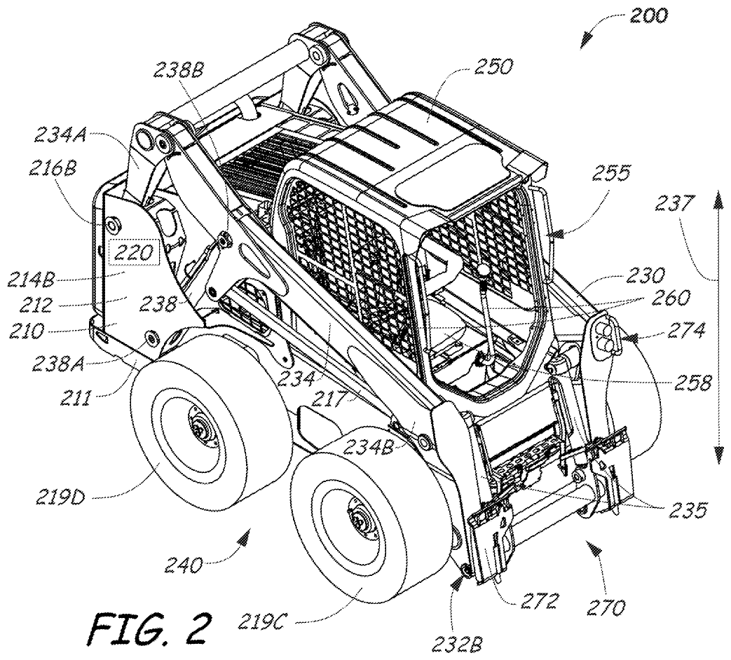

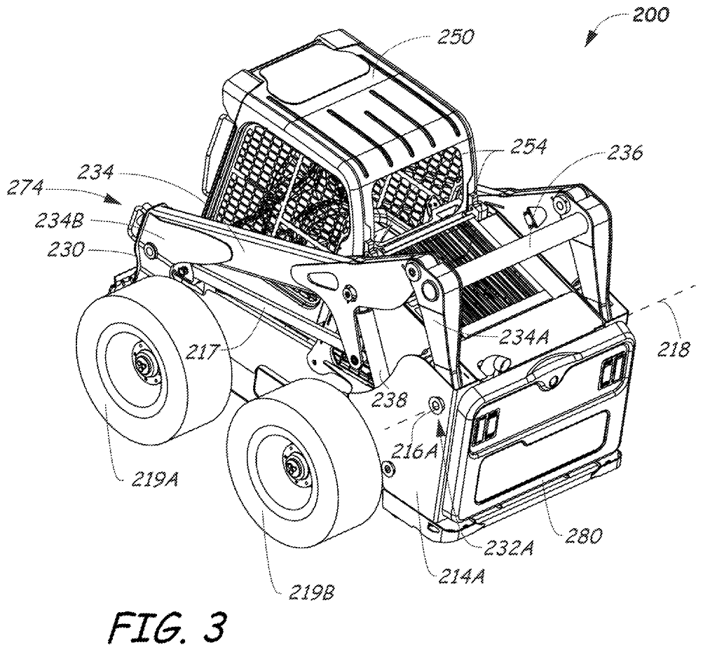

These concepts can be practiced on various power machines, as will be described below. A representative power machine on which the examples can be practiced is illustrated in diagram form in FIG. 1 and one example of such a power machine is illustrated in FIGS. 2 and 3 and described below before any examples are disclosed. For the sake of brevity, only one power machine is illustrated and discussed as being a representative power machine. However, as mentioned above, the examples below can be practiced on any of a number of power machines, including power machines of different types from the representative power machine shown in FIGS. 2 and 3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

FIG. 1 is a block diagram that illustrates the basic systems of a power machine 100, which can be any of a number of different types of power machines, upon which the examples discussed below can be advantageously incorporated. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that can perform a dedicated task. For example, some work vehicles have a lift arm to which an implement such as a bucket is attached such as by a pinning arrangement. The work element, i.e., the lift arm can be manipulated to position the implement to perform the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of different implements to the work element. One characteristic of such an implement carrier is that once an implement is attached to it, it is fixed to the implement (i.e., not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is configured to provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interface 170. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electrical sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task.

For example, the power machine can be a mower with a mower deck or other mower component as a work element, which may be movable with respect to the frame of the mower. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed examples may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both of the power machine and any implement to which is it coupled) that is capable of controlling at least some of the operator-controlled functions on the power machine.

FIGS. 2 and 3 illustrate a loader 200, which is one particular example of a power machine of the type illustrated in FIG. 1 where the examples discussed below can be advantageously employed. Loader 200 is a skid-steer loader, which is a loader that has tractive elements (in this case, four wheels) that are mounted to the frame of the loader via rigid axles. Here the phrase “rigid axles” refers to the fact that the loader 200 does not have any tractive elements that can be rotated or steered to help the loader accomplish a turn. Instead, a skid-steer loader has a drive system that independently powers one or more tractive elements on each side of the loader so that by providing differing tractive signals to each side, the machine will tend to skid over a support surface. These varying signals can even include powering tractive element(s) on one side of the loader to move the loader in a forward direction and powering tractive element(s) on another side of the loader to mode the loader in a reverse direction so that the loader will turn about a radius centered within the footprint of the loader itself. The term “skid-steer” has traditionally referred to loaders that have skid steering as described above with wheels as tractive elements. However, it should be noted that many track loaders also accomplish turns via skidding and are technically skid-steer loaders, even though they do not have wheels. For the purposes of this discussion, unless noted otherwise, the term skid-steer should not be seen as limiting the scope of the discussion to those loaders with wheels as tractive elements. Correspondingly, although some example power machines discussed herein are presented as skid-steer power machines, some examples disclosed herein can be implemented on a variety of other power machines. For example, some exemplary implementations can be implemented on compact loaders or compact excavators that do not accomplish turns via skidding.

Loader 200 is one particular example of the power machine 100 illustrated broadly in FIG. 1 and discussed above. To that end, features of loader 200 described below include reference numbers that are generally similar to those used in FIG. 1. For example, loader 200 is described as having a frame 210, just as power machine 100 has a frame 110. Loader 200 is described herein to provide a reference for understanding one environment on which the examples described below related to track assemblies and mounting elements for mounting the track assemblies to a power machine may be practiced. The loader 200 should not be considered limiting especially as to the description of features that loader 200 may have described herein that are not essential to the disclosed examples and thus may or may not be included in power machines other than loader 200 upon which the examples disclosed below may be advantageously practiced. Unless specifically noted otherwise, examples disclosed below can be practiced on a variety of power machines, with the loader 200 being only one of those power machines. For example, some or all of the concepts discussed below can be practiced on many other types of work vehicles such as various other loaders, excavators, trenchers, and dozers, to name but a few examples.

Loader 200 includes frame 210 that supports a power system 220, the power system being capable of generating or otherwise providing power for operating various functions on the power machine. Power system 220 is shown in block diagram form, but is located within the frame 210. Frame 210 also supports a work element in the form of a lift arm assembly 230 that is powered by the power system 220 and that can perform various work tasks. As loader 200 is a work vehicle, frame 210 also supports a traction system 240, which is also powered by power system 220 and can propel the power machine over a support surface. The lift arm assembly 230 in turn supports an implement interface 270, which includes an implement carrier 272 that can receive and secure various implements to the loader 200 for performing various work tasks and power couplers 274, to which an implement can be coupled for selectively providing power to an implement that might be connected to the loader. Power couplers 274 can provide sources of hydraulic or electric power or both. The loader 200 includes a cab 250 that defines an operator station 255 from which an operator can manipulate various control devices 259 to cause the power machine to perform various work functions. Cab 250 can be pivoted back about an axis that extends through mounts 254 to provide access to power system components as needed for maintenance and repair.

The operator station 255 includes an operator seat 258 and a plurality of operation input devices, including control levers 259 that an operator can manipulate to control various machine functions. Operator input devices can include buttons, switches, levers, sliders, pedals and the like that can be stand-alone devices such as hand operated levers or foot pedals or incorporated into hand grips or display panels, including programmable input devices. Actuation of operator input devices can generate signals in the form of electrical signals, hydraulic signals, or mechanical signals. Signals generated in response to operator input devices are provided to various components on the power machine for controlling various functions on the power machine. Among the functions that are controlled via operator input devices on loader 200 include control of the tractive elements 219, the lift arm assembly 230, the implement carrier 272, and providing signals to any implement that may be operably coupled to the implement.

Loaders can include human-machine interfaces including display devices that are provided in the cab 250 to give indications of information relatable to the operation of the power machines in a form that can be sensed by an operator, such as, for example audible or visual indications. Audible indications can be made in the form of buzzers, bells, and the like or via verbal communication. Visual indications can be made in the form of graphs, lights, icons, gauges, alphanumeric characters, and the like. Displays can provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided. Other power machines, such walk behind loaders may not have a cab nor an operator compartment, nor a seat. The operator position on such loaders is generally defined relative to a position where an operator is best suited to manipulate operator input devices.

Various power machines that can include or interacting with the examples discussed below can have various different frame components that support various work elements. The elements of frame 210 discussed herein are provided for illustrative purposes and frame 210 is not the only type of frame that a power machine on which the examples can be practiced can employ.

Frame 210 of loader 200 includes an undercarriage or lower portion 211 of the frame and a mainframe or upper portion 212 of the frame that is supported by the undercarriage. The mainframe 212 of loader 200, in some examples is attached to the undercarriage 211 such as with fasteners or by welding the undercarriage to the mainframe. Alternatively, the mainframe and undercarriage can be integrally formed. Mainframe 212 includes a pair of upright portions 214A and 214B located on either side and toward the rear of the mainframe that support lift arm assembly 230 and to which the lift arm assembly 230 is pivotally attached. The lift arm assembly 230 is illustratively pinned to each of the upright portions 214A and 214B. The combination of mounting features on the upright portions 214A and 214B and the lift arm assembly 230 and mounting hardware (including pins used to pin the lift arm assembly to the mainframe 212) are collectively referred to as joints 216A and 216B (one is located on each of the upright portions 214) for the purposes of this discussion. Joints 216A and 216B are aligned along an axis 218 so that the lift arm assembly is capable of pivoting, as discussed below, with respect to the frame 210 about axis 218. Other power machines may not include upright portions on either side of the frame or may not have a lift arm assembly that is mountable to upright portions on either side and toward the rear of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 210 also supports a pair of tractive elements in the form of wheels 219A-D on either side of the loader 200.

The lift arm assembly 230 shown in FIGS. 2 and 3 is one example of many different types of lift arm assemblies that can be attached to a power machine such as loader 200 or other power machines on which examples of the present discussion can be practiced. The lift arm assembly 230 is what is known as a vertical lift arm, meaning that the lift arm assembly 230 is moveable (i.e., the lift arm assembly can be raised and lowered) under control of the loader 200 with respect to the frame 210 along a lift path 237 that forms a generally vertical path. Other lift arm assemblies can have different geometries and can be coupled to the frame of a loader in various ways to provide lift paths that differ from the radial path of lift arm assembly 230. For example, some lift paths on other loaders provide a radial lift path. Other lift arm assemblies can have an extendable or telescoping portion. Other power machines can have a plurality of lift arm assemblies attached to their frames, with each lift arm assembly being independent of the other(s). Unless specifically stated otherwise, none of the inventive concepts set forth in this discussion are limited by the type or number of lift arm assemblies that are coupled to a particular power machine.

The lift arm assembly 230 has a pair of lift arms 234 that are disposed on opposing sides of the frame 210. A first end 232A of each of the lift arms 234 is pivotally coupled to the power machine at joints 216 and a second end 232B of each of the lift arms is positioned forward of the frame 210 when in a lowered position as shown in FIG. 2. Joints 216 are located toward a rear of the loader 200 so that the lift arms extend along the sides of the frame 210. The lift path 237 is defined by the path of travel of the second end 232B of the lift arms 234 as the lift arm assembly 230 is moved between a minimum and maximum height.

Each of the lift arms 234 has a first portion 234A of each lift arm 234 is pivotally coupled to the frame 210 at one of the joints 216 and the second portion 234B extends from its connection to the first portion 234A to the second end 232B of the lift arm assembly 230. The lift arms 234 are each coupled to a cross member 236 that is attached to the first portions 234A. Cross member 236 provides increased structural stability to the lift arm assembly 230. A pair of actuators 238, which on loader 200 are hydraulic cylinders configured to receive pressurized fluid from power system 220, are pivotally coupled to both the frame 210 and the lift arms 234 at pivotable joints 238A and 238B, respectively, on either side of the loader 200. The actuators 238 are sometimes referred to individually and collectively as lift cylinders. Actuation (i.e., extension and retraction) of the actuators 238 cause the lift arm assembly 230 to pivot about joints 216 and thereby be raised and lowered along a fixed path illustrated by arrow 237. Each of a pair of control links 217 are pivotally mounted to the frame 210 and one of the lift arms 232 on either side of the frame 210.

The control links 217 help to define the fixed lift path of the lift arm assembly 230.

Some lift arms, most notably lift arms on excavators but also possible on loaders, may have portions that are controllable to pivot with respect to another segment instead of moving in concert (i.e., along a pre-determined path) as is the case in the lift arm assembly 230 shown in FIG. 2. Some power machines have lift arm assemblies with a single lift arm, such as is known in excavators or even some loaders and other power machines. Other power machines can have a plurality of lift arm assemblies, each being independent of the other(s).

An implement interface 270 is provided proximal to a second end 232B of the lift arm assembly 234. The implement interface 270 includes an implement carrier 272 that is capable of accepting and securing a variety of different implements to the lift arm 230. Such implements have a complementary machine interface that is configured to be engaged with the implement carrier 272. The implement carrier 272 is pivotally mounted at the second end 232B of the lift arm 234. Implement carrier actuators 235 are operably coupled the lift arm assembly 230 and the implement carrier 272 and are operable to rotate the implement carrier with respect to the lift arm assembly. Implement carrier actuators 235 are illustratively hydraulic cylinders and often known as tilt cylinders.

By having an implement carrier capable of being attached to a plurality of different implements, changing from one implement to another can be accomplished with relative ease. For example, machines with implement carriers can provide an actuator between the implement carrier and the lift arm assembly, so that removing or attaching an implement does not involve removing or attaching an actuator from the implement or removing or attaching the implement from the lift arm assembly. The implement carrier 272 provides a mounting structure for easily attaching an implement to the lift arm (or other portion of a power machine) that a lift arm assembly without an implement carrier does not have.

Some power machines can have implements or implement like devices attached to it such as by being pinned to a lift arm with a tilt actuator also coupled directly to the implement or implement type structure. A common example of such an implement that is rotatably pinned to a lift arm is a bucket, with one or more tilt cylinders being attached to a bracket that is fixed directly onto the bucket such as by welding or with fasteners. Such a power machine does not have an implement carrier, but rather has a direct connection between a lift arm and an implement.

As briefly mentioned above, the implement interface 270 also includes the power couplers 274 available for connection to an implement on the lift arm assembly 230. The power couplers 274 includes a pressurized hydraulic fluid port to which an implement can be removably coupled. The pressurized hydraulic fluid port selectively provides pressurized hydraulic fluid for powering one or more functions or actuators on an implement. The power couplers 274 can also include an electrical power source for powering electrical actuators or an electronic controller on an implement. The power couplers 274 also exemplarily includes electrical conduits that are in communication with a data bus on the loader 200 to allow communication between a controller on an implement and other electronic devices on the loader 200.

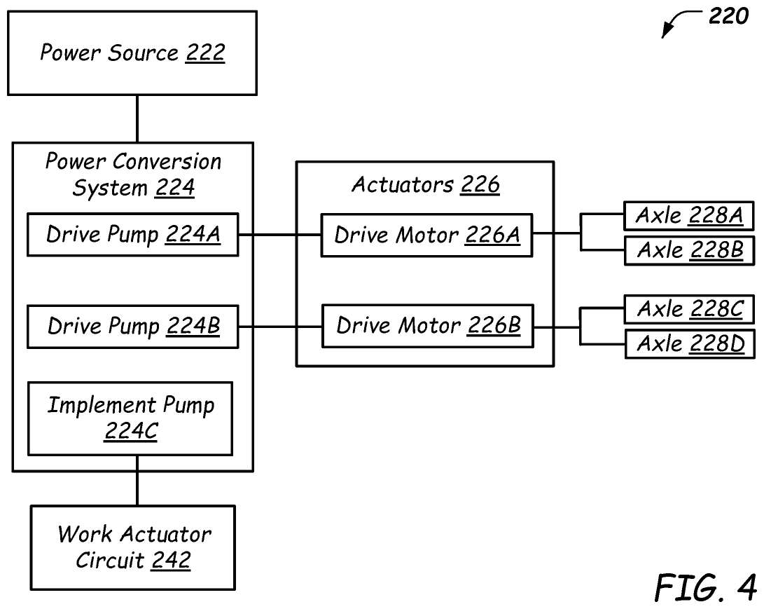

Frame 210 supports and generally encloses the power system 220 so that the various components of the power system 220 are not visible in FIGS. 2 and 3. FIG. 4 includes, among other things, a diagram of various components of the power system 220. Power system 220 includes one or more power sources 222 that are capable of generating or storing power for use on various machine functions. On loader 200, the power system 220 includes an internal combustion engine. Other power machines, including those presented below, can include electric generators, rechargeable batteries, various other power sources or any combination of power sources that can provide power for given power machine components. The power system 220 also includes a power conversion system 224, which is operably coupled to the power source 222. Power conversion system 224 is, in turn, coupled to one or more actuators 226, which can perform a function on the power machine. Power conversion systems in various power machines can include various components, including mechanical transmissions, hydraulic systems, and the like. The power conversion system 224 of loader 200 includes a pair of hydrostatic drive pumps 224A and 224B, which are selectively controllable to provide a power signal to drive motors 226A and 226B. The drive motors 226A and 226B in turn are each operably coupled to axles, with drive motor 226A being coupled to axles 228A and 228B and drive motor 226B being coupled to axles 228C and 228D. The axles 228A-D are in turn coupled to tractive elements 219A-D, respectively. The drive pumps 224A and 224B can be mechanically, hydraulic, or electrically coupled to operator input devices to receive actuation signals for controlling the drive pumps.

The arrangement of drive pumps, motors, and axles in loader 200 is but one example of an arrangement of these components. As discussed above, loader 200 is a skid-steer loader and thus tractive elements on each side of the power machine are controlled together via the output of a single hydraulic pump, either through a single drive motor as in loader 200 or with individual drive motors. Various other configurations and combinations of hydraulic drive pumps and motors can be employed as may be advantageous.

The power conversion system 224 of loader 200 also includes a hydraulic implement pump 224C, which is also operably coupled to both the power source 222 and work actuator circuit 238C. Work actuator circuit 238C includes lift cylinders 238 and tilt cylinders 235 as well as control logic to control actuation thereof. The control logic selectively allows, in response to operator inputs, for actuation of the lift cylinders or tilt cylinders. In some machines, the work actuator circuit 238C also includes control logic to selectively provide a pressurized hydraulic fluid to an attached implement. The control logic of loader 200 can include an open center, three-spool valve in a series arrangement. For example, the spools can be arranged to give priority to the lift cylinders, then the tilt cylinders, and then pressurized fluid to an attached implement.

The description of power machine 100 and loader 200 above is provided for illustrative purposes, to provide illustrative environments on which the examples discussed below can be practiced. While the examples discussed can be practiced on a power machine such as is generally described by the power machine 100 shown in the block diagram of FIG. 1 and more particularly on a loader such as track loader 200, unless otherwise noted or recited, the concepts discussed below are not intended to be limited in their application to the environments specifically described above.

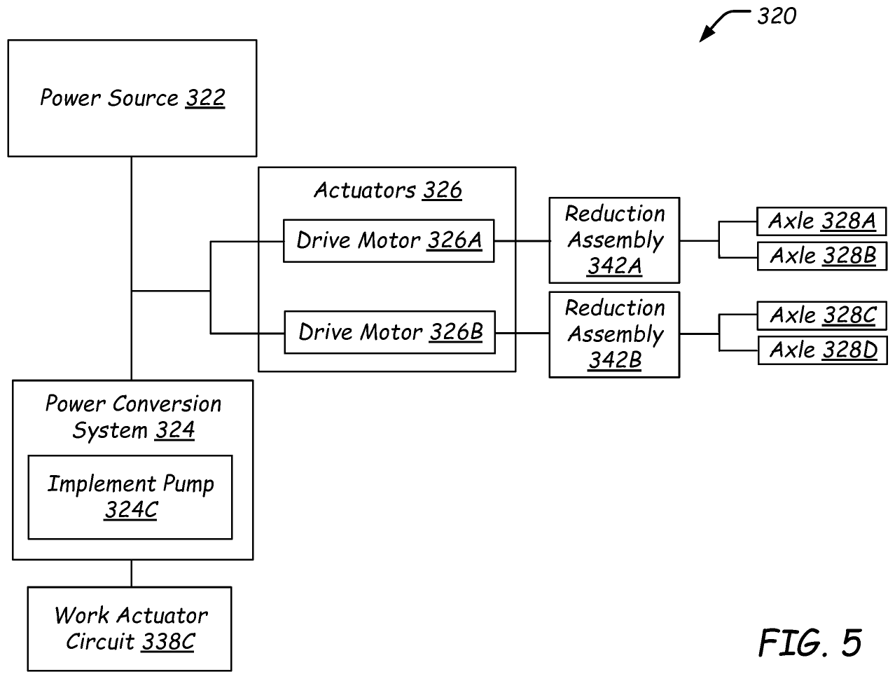

As briefly mentioned herein, some power machines can utilize powers sources within a power system other than an internal combustion engine (e.g., the power source 222 of the power system 220 of the loader 200 in FIG. 4) to provide power for various power machine components of the power machine. In this regard, FIG. 5 illustrates another example power system of a power machine according to examples of the present disclosure. Power system 320 of FIG. 5 is another particular example of a power system that can be implemented on a power machine, such as the power machine or loader 200 illustrated broadly in FIGS. 2-5 and discussed above. To that end, features of power system 320 described below include reference numbers that are generally similar to those used in FIG. 4. For example, power system 320 is described as having a power source 322, just as the power system 220 has the power source 222.

In some aspects, however, the power system 320 differs from the power system 220. In particular, the power source 322 of the power system 320 is a rechargeable battery that is configured to provide electrical power to actuators 326. In the illustrated example, the actuators 326 include electrically operated first and second drive motors 326A, 326B, in contrast to the hydraulically operated drive motors 226A, 226B of the power system 220. Thus, power conversion system 324 of power system 320 can include (as needed) only a hydraulic implement pump 324C that is electrically operated by the power source 322 and operably coupled to a work actuator circuit 338C to provide pressurized hydraulic fluid to one or more actuators (such as, e.g., tilt cylinders 235 in FIG. 2 and lift cylinders 238 in FIG. 3). In some examples, the one or more actuators in communication with the work actuator circuit 338C can be configured as electrically powered actuators that can be powered by the power source 322 instead of the hydraulic implement pump 324C. In some examples, the power system 320 can be configured to power one or more electrically operated coolant pumps of a cooling system of the power machine that can be configured to provide coolant to the first and second drive motors 326A, 326B.

In some examples, the power source 322 can include a plurality of rechargeable batteries. In some such examples, the power system 320 can include a first power source configured to power the first drive motor 326A and a second power source configured to power the second drive motor 326B. In other such examples, the first power source can be configured to power the first and second drive motors 326A, 326B and the second power source can be configured to power the implement pump 324C or other actuators (such as, e.g., tilt cylinders 235 in FIG. 2 and lift cylinders 238 in FIG. 3).

Referring still to FIG. 5, the drive motors 326A, 326B are each operably coupled to axles, with first drive motor 326A being coupled to first and second axles 328A, 328B and second drive motor 326B being coupled to third and fourth axles 328C, 328D. The axles 328A, 328B, 328C, 328D can in turn be coupled to tractive elements (such as, e.g., the wheels 219A, 219B, 219C, 219D in FIGS. 2 and 3). In some examples, the first and second drive motors 326A, 326B can be electrically coupled to operator input devices (such as, e.g., control levers 259 in FIG. 2) that can control operation of the first and second drive motors 326A, 326B. For example, a controller (not shown) of the power machine can be in electrical communication with the power source 322 and the drive motors 326A, 326B. In some such examples, the controller can be configured to receive signals from the operator input devices and to control the drive motors 326A, 326B based on the received signals.

Because electric motors (e.g., the drive motors 326A, 326B) are typically configured to optimally operate at high speeds, one or more intermediary power transmission components may be required between such a motor and one or more drive axles to alter the output speed or the output torque provided by the electric motor to the drive axle (e.g., to reduce speed and increase torque). Further, such intermediary components can sometimes also provide increased operational efficiency of the electric motors. Accordingly, the power system 320 can further include one or more reduction assemblies (i.e., one or more assemblies configured to operate mechanically to modify a rotational speed of rotational power) arranged to transmit power, while reducing the corresponding rotational speed, between a motor and another powered component. For example, known configurations of reduction assemblies can include meshed gears, belt drives, chain drives, etc.

In the illustrated example, the power system 320 includes a first reduction assembly 342A and a second reduction assembly 342B. The first reduction assembly 342A is operatively coupled to the first drive motor 326A and to the first and second axles 328A, 328B. Likewise, the second reduction assembly 342B is operatively coupled to the second drive motor 326B and to the third and fourth axles 328C, 328D. In some examples, the power system 320 can include four reduction assemblies, with one reduction assembly operatively coupled to a corresponding one of the axles 328A, 328B, 328C, 328D. In some such examples, the power system 320 can include four drive motors, with one drive motor operatively coupled to a corresponding one of the axles 328A, 328B, 328C, 328D.

As illustrated, and as further discussed below, the reduction assemblies 342A, 342B can be configured as gearboxes that can operate to convert a first input speed to a second (e.g., lower) output speed. In this regard, any variety of gear configurations are possible, including configurations with spur gear systems, with planetary gear systems, or other arrangements. Further, other known devices to reduce powered rotation can be used in some examples, including chain-driven systems, belt-driven or other friction-operated systems, fluidic systems, etc.

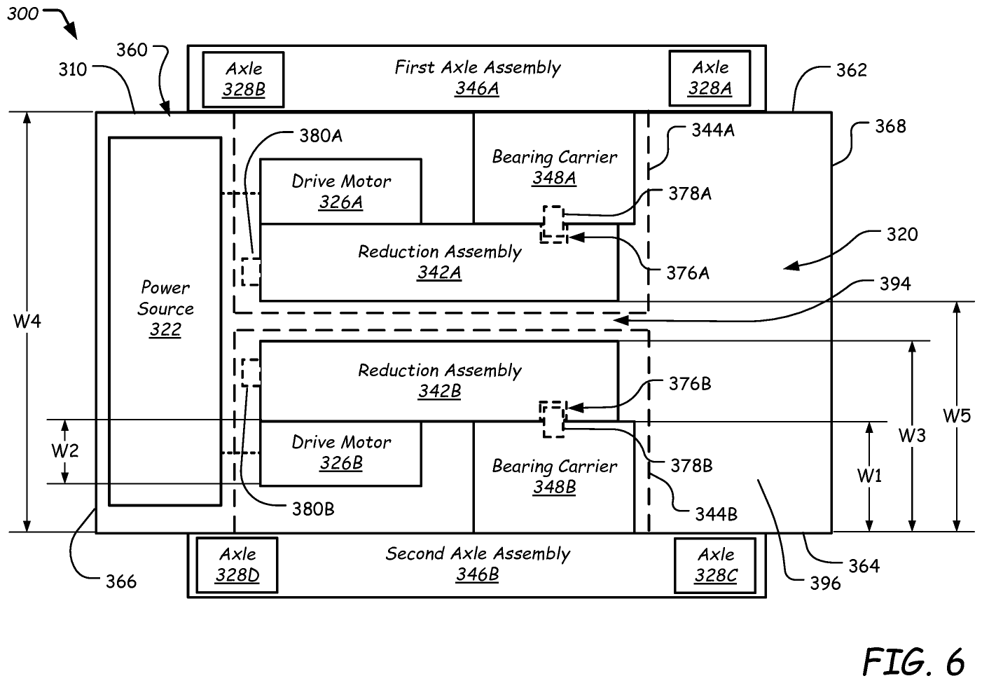

It should be appreciated that the power system 300 of FIG. 5 can be implemented on various power machines in various configurations to provide the benefits of the disclosed technology, including configurations that provide optimized spacing within a frame of the power machine. Accordingly, FIG. 6 illustrates an example power machine having the power system 320 of FIG. 5 according to examples of the present disclosure. Power machine 300 of FIG. 6 is another particular example of the power machine or loader 200 illustrated broadly in FIGS. 2-5 and generally discussed above. To that end, features of power machine 300 described below include reference numbers that are generally similar to those used in FIGS. 2-5 and preceding discussion of particular components generally applies to similarly named and numbered components presented below. For example, power machine 300 is described as having a frame 310 and the power system 320, just as loader 200 has the frame 210 and the power system 220.

In some aspects, the power machine 300 differs from the loader 200 as described above.

For example, the power machine 300 includes the example power system 320 (see FIG. 5) that differs from the example power system 220 of the loader 200 (see FIG. 4). In the illustrated example, in particular, the power system 320 as configured for the power machine 300 includes a first motor sub-assembly 344A and a second motor sub-assembly 344B (as indicated by dashed boxes, respectively) arranged within a frame cavity 360 of the frame 310. In particular, the two motor sub-assemblies 344A, 344B are arranged with lateral symmetry relative to a centerline of the frame 310 (and the frame cavity 360), with lateral spacing between particular components as further discussed below. In some examples, however, a different alignment or number of drive sub-assemblies may be provided (e.g., with one drive assembly or more than two drive sub-assemblies, with the drive sub-assemblies non-symmetrically arranged on the frame 310, etc.).

Still referring to FIG. 6, the power source 322 is supported by the frame 310 rearward of the first and second motor sub-assemblies 344A, 344B. Such an arrangement can provide improved placement of the power source 322 for weight distribution and other factors (e.g., center of gravity location), and improved placement of the motor sub-assemblies 344A, 344B for power transmission and cooling. Further, as generally noted above, an efficiently packaged motor sub-assembly according to the disclosed technology can be installed to provide ample space for the power source 322 toward the rear of the frame 310. In other arrangements, however, a power source may be otherwise located relative to a motor sub-assembly (e.g., relative to one or more drive motor sub-assemblies otherwise similar to the sub-assemblies 344A, 344B).

Generally, the frame cavity 360 can be defined by a first side 362, a second side 364 that is laterally opposite the first side 362, a rear side 366, and a front side 368 that is opposite the rear side 366 of the frame 310. In particular, some frame cavities can be defined between laterally opposed sidewalls that support (or define) opposing axle assemblies. For example, as shown, the first side 362 of the frame cavity 360 is defined by an inboard support wall of (and for) a first axle assembly 346A, and the second side 364 of the frame is defined by an inboard support wall of (and for) a second axle assembly 346A. In some examples, other sidewalls can define a frame cavity (e.g., frame sidewalls that support distinct forward and rearward axle assemblies on opposing lateral sides of a power machine, rather than a single axle assembly on each lateral side). In some examples, a frame can include two or more frame cavities. In some such examples, motor sub-assemblies can be arranged in different frame cavities from each other or from a power source (e.g., with the motor sub-assemblies in a forward frame cavity and a power source in a rear frame cavity). In some examples, a frame cavity of a power machine frame can define a generally circular or triangular shape.

With continued reference to FIG. 6, the first motor sub-assembly 344A is arranged within the frame cavity 360 along the first side 362 of the frame 310 and is configured to power the first axle assembly 346A. In the illustrated example, the first axle assembly 346A is arranged along the first side 362 of the frame 310 outboard of the frame cavity 360 and includes the first and second axles 328A, 328B. Likewise, the second motor sub-assembly 344B is arranged within the frame cavity 360 along the second side 364 of the frame 310 and is configured to power the second axle assembly 346B of the power machine 300. The second axle assembly 346B is arranged along the second side 364 of the frame 310 outboard of the frame cavity 360 and includes the third and fourth axles 328C, 328D. In some cases, as further discussed below, the axle assemblies 346A, 346B can be chain drive assemblies. In other cases, other known types of axle assemblies can be similarly (or otherwise) utilized to transmit rotational power from the motor sub-assemblies 344A, 344B to relevant axles and the associated tractive elements.

As also noted above, some examples of the disclosed technology can include improved arrangements of drive system components. In this regard, for example, the first motor sub-assembly 344A of the power machine 300 includes the first drive motor 326A (e.g., a first electric motor), the first reduction assembly 342A, and a first bearing carrier 348A. In particular, the first bearing carrier 348A is fixedly attached to and operably supported by the first side 362 of the frame 310 and is operably engaged with the first axle assembly 346A. The first reduction assembly 342A is operably supported by the first bearing carrier 348A relative to the frame 310, with the first reduction assembly 342A inboard of the first bearing carrier 348A, and is also operably engaged with the first bearing carrier 348A to power the first axle assembly 346A via the first bearing carrier 348A. The first drive motor 326A is operably supported by the first reduction assembly 342A relative to the first bearing carrier 348A, and thereby supported by the first reduction assembly 342A and the first bearing carrier 348A relative to the frame 310. In particular, the first drive motor 326A can thus be supported to extend outboard of the first reduction assembly 342A, and inboard of the first axle assembly 346A (or other relevant sidewall of the frame cavity 360). Thus, the first drive motor 326A can be operably engaged with the first reduction assembly 342A to power the first axle assembly 346A via the first reduction assembly 342A and first bearing carrier 348A, using power from the power source 322.

In some cases, including as shown in FIG. 6, the second motor sub-assembly 344B of the power machine 300 can be arranged similarly to the first motor sub-assembly 344A, but on the opposing lateral side 364 of the power machine 300 (e.g., supported on an opposing sidewall of the frame cavity 360). Thus, briefly, the second bearing carrier 348B can be fixedly attached to and operably supported by the second side 364 of the frame 310 and operably engaged with the second axle assembly 346B, and the second reduction assembly 342B can be operably supported by the second bearing carrier 348B relative to the frame 310 and inboard of the second bearing carrier 348B. Further, the second drive motor 326B can be operably supported by the second reduction assembly 342B relative to the second bearing carrier 348B, with the second drive motor 326B outboard of the second reduction assembly 342B and inboard of the second axle assembly 346B. As also discussed below, such a generally symmetrical arrangement can provide various structural and operational benefits, including relative to serviceability (e.g., relative to ease of installation and removal of the motor sub-assemblies 344A, 344B). However, arrangements of motor sub-assemblies may not be laterally (or otherwise) symmetrical in some cases, or may include different or differently arranged components on different sides of a power machine frame.

In some cases, a reduction assembly can be supported relative to a power machine frame only by a bearing carrier or other power transmission sub-assembly. In some cases, a reduction assembly can be further supported by other structural connections with a frame. For example, the first reduction assembly 342A can be removably fixed to a bottom surface 396 of the frame cavity 360 via a first mounting structure (e.g., a first tab 380A at the bottom surface 396 of the frame cavity 360, as shown in FIG. 6). Likewise, the second reduction assembly 342B can be removably fixed to the bottom surface 396 of the frame cavity 360 via a second mounting structure (e.g., a second tab 380B, as shown in FIG. 6).

In some cases, drive motors can be secured relative to a frame only (or primarily) via connection of the drive motors to a motor sub-assembly, which is in turn mounted directly or indirectly to a power machine frame. Correspondingly, in the illustrated example, the drive motors 326A, 326B of the motor sub-assemblies 344A, 344B are attached to the frame 310 only via attachment to the respective reduction assembly 342A, 342B, which may in turn be only (or primarily) supported relative to the frame by the respective bearing carrier 348A, 348B. In some examples, either of the motor sub-assemblies 344A, 344B can be configured such that the drive motor 326A, 326B, the reduction assembly 342A, 342B, or the bearing carrier 348A, 348B do not contact the bottom surface 396 of the frame cavity 360. In some examples, the reduction assembly 342A, 342B can be cantilevered from the bearing carrier 348A, 348B (e.g., with the reduction assembly 342A, 342B only or primarily supported by the bearing carrier 348A, 348B relative to the frame 310). In some examples, the drive motor 326A, 326B can be cantilevered from the reduction assembly 342A, 342B (e.g., with the drive motor 326A, 326B only or primarily supported by the reduction assembly 342A, 342B relative to the frame 310 or the bearing carrier 348A, 348B).

With continued reference to FIG. 6, the first and second reduction assemblies 342A, 342B can be operably engaged with the first and second bearing carriers 348A, 348B, respectively, in various configurations with various known mechanical connectors used to transmit rotational power. In the illustrated example, the first reduction assembly 342A includes a first tube 376A that is configured to operatively engage a first shaft 378A of the first bearing carrier 348A, and the second reduction assembly 342B includes a second tube 376B that is configured to operatively engage a second shaft 378B of the second bearing carrier 348B. For example, the shafts 378A, 378B can be splined and the tubes 376A, 376B can include a plurality of grooves configured to operatively receive the splined shafts 378A, 378B. In some examples, the shafts 378A, 378B can be included on the reduction assemblies 342A, 342B rather than on the bearing carriers 348A, 348B, respectively, and the tubes 376A, 376B can be included on the bearing carriers 348A, 348B rather than on the reduction assemblies 342A, 342B, respectively. In other examples, similar or other arrangements (not shown) can also be used to operably engage the drive motors 326A, 326B with the reduction assemblies 342A, 342B. Likewise, some examples can include otherwise configured for connecting rotating bodies for power transmission, including any variety of known configurations for interconnection of rotating shafts, gears, flywheels, etc.

It should be appreciated that dimensional configurations of the motor sub-assemblies 344A, 344B can be beneficial to the processes of installing and servicing the motor sub-assemblies 344A, 344B. For example, in some implementations, a laterally spaced arrangement of the reduction assemblies 342A, 342B, relative to each other and to the sides 362, 364 of the frame cavity 360, can permit operators to install or uninstall either of the motor sub-assemblies 344A, 344B (partly or fully) while the other of the sub-assemblies 344A, 344B remains installed (partly or fully) on the frame 310. An example implementation of such a laterally spaced arrangement is illustrated in FIG. 6, with particular widths indicated for the second reduction assembly 342B. In some examples, the first reduction assembly 342A can exhibit similar dimensions and spacing (e.g., can be symmetrically arranged relative to the second reduction assembly 342B across a centerline of the power machine 300).

In a particular example, as shown in FIG. 6, the second motor sub-assembly 344B defines a first lateral width W1 that corresponds to a first lateral spacing of the second reduction assembly 342B inboard from the second side 364 of the frame 310 (e.g., inboard from a frame wall at which the second reduction assembly 342B is operably supported). In the illustrated example, the first lateral width W1 is defined by a lateral width of the second bearing carrier 348B itself, but other arrangements may exhibit other widths (e.g., where a bearing carrier is recessed into or spaced inboard from the relevant frame sidewall). The second motor sub-assembly 344B also defines a second lateral width W2 that corresponds to a lateral extension of the second drive motor 326B outboard from the respective second reduction assembly 342B. As shown in the example of FIG. 6, the second drive motor 326B can be mounted flush against the outboard side of the reduction assembly 342B. Accordingly, the second lateral width W2 can be defined by a lateral width of the second drive motor 326B itself. However, the width of a drive motor may differ from the width W2 in other arrangements (e.g., where the drive motor is recessed into or spaced outboard from the relevant reduction assembly).

Also in the illustrated example, the second lateral width W2 is smaller than the first lateral width W1, so that the second drive motor 326B is spaced laterally from the second side 364 of the frame 310 when the second motor sub-assembly 344B is installed (as shown in FIG. 6). Thus, in some such implementations, the second drive motor 326B may be appropriately supported for operation while also being suitably vibrationally isolated from the frame 310, as needed, and also spaced apart from the frame 310 and other components for improved air flow (cooling) around the second drive motor 326B (among other benefits). For example, the second drive motor 326B (like the first drive motor 326A) can be spaced laterally or vertically from the frame 310 such that the motor 326B does not directly contact the frame 310. The motor 326B (or 326A) can thus, for example, be in mechanical communication with the frame 310 relative to transmission of vibrations only via the operational support provided by reduction assembly 342B (or 342A). In some examples, the second lateral width W2 can be in a range of 40% and 98% of the first lateral width W1, in a range of 60% and 95% of the first lateral width W1, or in a range of 85% and 95% of the first lateral width W1.

In some implementations, and as briefly mentioned above, a laterally spaced arrangement for multiple motor sub-assemblies on a power machine can allow an operator to install or uninstall part or all of one of the motor sub-assemblies while part or all of another of the sub-assemblies remains operably supported and engaged on the power machine. As one example, as shown in FIG. 6, the second motor sub-assembly 344B (e.g., and also the first motor sub-assembly 344A, as noted above) defines a third lateral width W3 that corresponds to an installed total width that combines the first lateral width W1 and a lateral width of the second reduction assembly 342B. (Correspondingly, the lateral width of the second reduction assembly 342B can be considered as being equal to the width W3 minus the width W1.) To allow laterally adjacent installation of the motor sub-assemblies 344A, 344B, the third lateral width W3 is less than half of a fourth lateral width W4 that extends laterally across the entire available width of the frame cavity 360 (i.e., a cavity width in a lateral direction). Accordingly, with similar widths also implemented for the first motor sub-assembly 344A (e.g., the same widths W1 through W3, measured from the first side 362), a lateral gap 394 is defined between the installed motor sub-assemblies 344A, 344B (e.g., as also corresponds to a lateral width W5, between the second side 364 and the first reduction assembly 342A, less the width W3 of the second motor sub-assembly 344B).

With appropriate configuration of the relevant sub-assembly widths (e.g., W1 through W3, relative to W4) the lateral gap 394 can be sufficiently large to allow part or all of the second motor sub-assembly 344B to be removed while the entire first motor sub-assembly 344A remains in place. For example, the second shaft 378B of the second bearing carrier 348B (or a similar protruding component on a reduction assembly) can be sized to protrude inboard (or outboard, for a reduction assembly) by a lateral distance that is less than a width of the gap 394. Accordingly, the disclosed arrangement can permit a lateral movement of the second reduction assembly 342B toward the opposing first reduction assembly 342A that is sufficiently large to allow complete disengagement of the second reduction assembly 342B from the second bearing carrier 348B, without the second reduction assembly 342B needing to be moved by more than the width of the gap 394 (e.g., while the first reduction assembly 342A of the opposing first motor sub-assembly 344A remains installed). In some examples, the installed lateral width W3 can be in a range between 30% and 49% of the cavity lateral width W4, in a range between 35% and 49% of the cavity lateral width W4, or in a range between 40% and 48% of the cavity lateral width W4, with corresponding potential ranges of values for the gap 394.

As a further benefit of the disclosed drive system configurations, an overall width of a power machine can be significantly reduced relative to comparable conventional configurations. In some examples, the disclosed motor sub-assemblies can allow for flexible adoption of various drive motors for frames with chain cases or other outboard axle assemblies. As generally discussed above relative to the width W3, a reduction in overall motor sub-assembly width can allow the use of motors of a range of sizes (or types) to power an axle assembly via a common connection assembly (e.g., via a particularly configured bearing carrier, with the bearing carrier secured at a single predetermined position on an inboard side of a chain case). Thus, for example, some implementations can provide significantly increased flexibility for manufacturers to selectively employ a common frame design with different types of power systems.

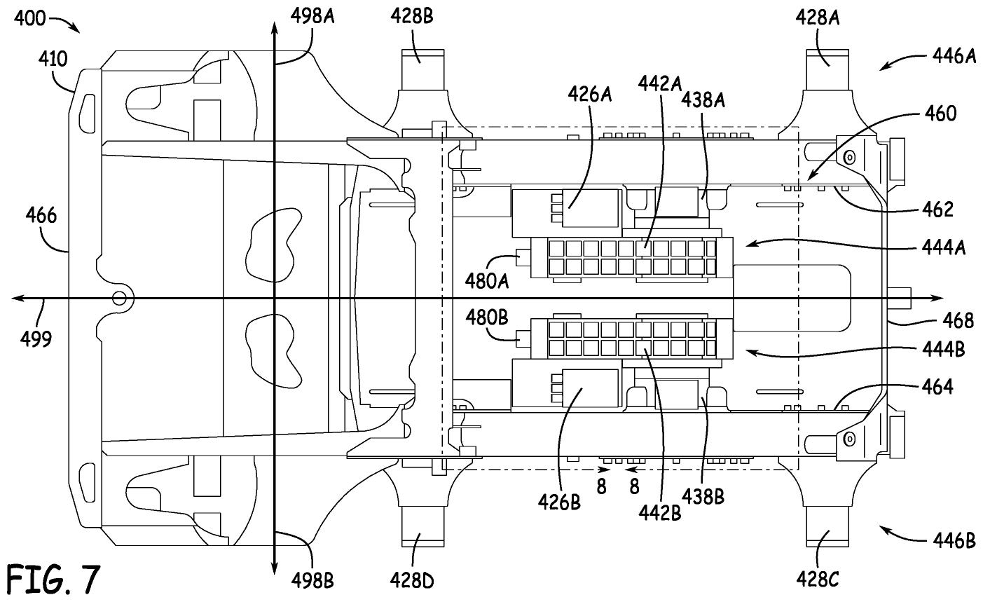

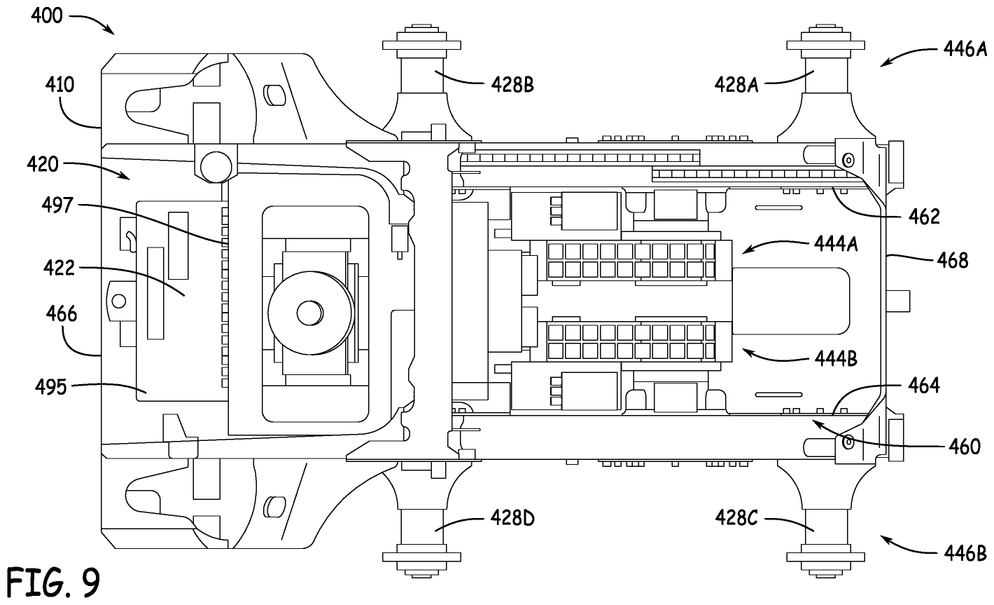

Referring now to FIGS. 7-23, an example power machine having a power system is shown according to examples of the present disclosure. Power machine 400 of FIGS. 7-23 is another particular example of the power machine or loader 200 illustrated broadly in FIGS. 2-4 and of the power machine 300 illustrated in FIGS. 5 and 6. To that end, features of power machine 400 described below include reference numbers that are generally similar to those used in FIGS. 2-6 and preceding discussion of particular components generally applies to similarly named and numbered components presented below. For example, power machine 400 is described as having a frame 410 and a power system 420, just as loader 200 has the frame 210 and the power system 220 and as the power machine 300 has the frame 310 and the power system 320. Further, the power system 420 of the power machine 400 is similar to the power system 320 of the power machine 300, in at least that a power source 422 (see FIG. 9) of the power system 420 is a rechargeable battery.

In particular, the power machine 400 includes first and second motor sub-assemblies 444A, 444B as specific examples of the motor sub-assemblies 344A, 344B in FIG. 6.

Correspondingly, the motor sub-assemblies 444A, 444B are arranged within a frame cavity 460 that is defined by a first side 462 (e.g., a first sidewall) and a second side 464 laterally opposite the first side 462 (e.g., a second sidewall). In some cases, a frame cavity can also be otherwise bounded (e.g., at a rear side 466, at a front side 468, and a cavity dividing wall disposed between the rear and front sides 466, 468, etc.).

Referring specifically to FIG. 7, the first motor sub-assembly 444A is arranged within the frame cavity 460 along the first side 462 of the frame 410 and is configured to power a first axle assembly 446A. The first axle assembly 446A is arranged along the first side 462 outboard of the frame cavity 460 and can include first and second axles 428A, 428B (e.g., for wheeled tractive elements (not shown)). Likewise, the second motor sub-assembly 444B is arranged within the frame cavity 460 along the second side 464 of the frame 410 and is configured to power a second axle assembly 446B arranged along the second side 464 of the frame 410 outboard of the frame cavity 460 (e.g., that includes third and fourth axles 428C, 428D). In other words, the first motor assembly 444A (along with the first axle assembly 446A) is arranged on the frame 410 toward a first lateral direction 489A, relative to a front to back direction 499 of the power machine 400, along the first side 462 of the frame 410. Similarly, the second motor assembly 444B (along with the second axle assembly 446B) is arranged along the second side 464 of the frame 410, in a second lateral direction 498B that is opposite the first lateral direction 498A.

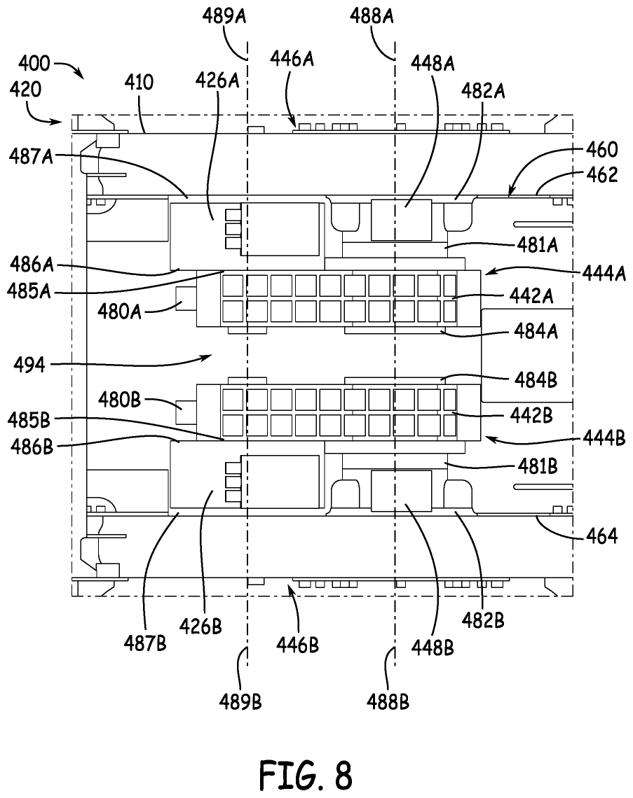

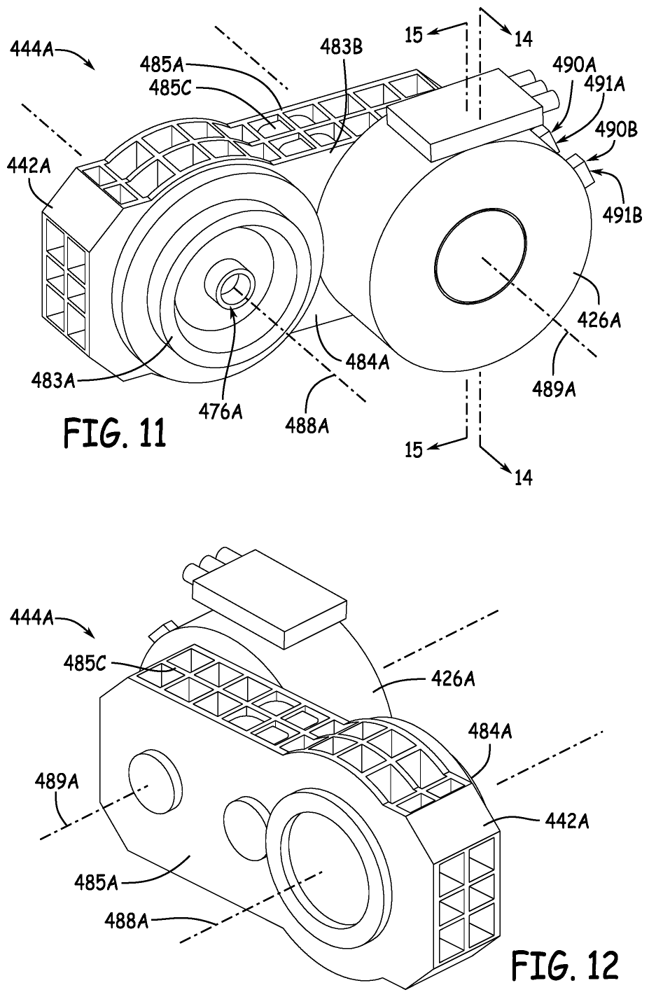

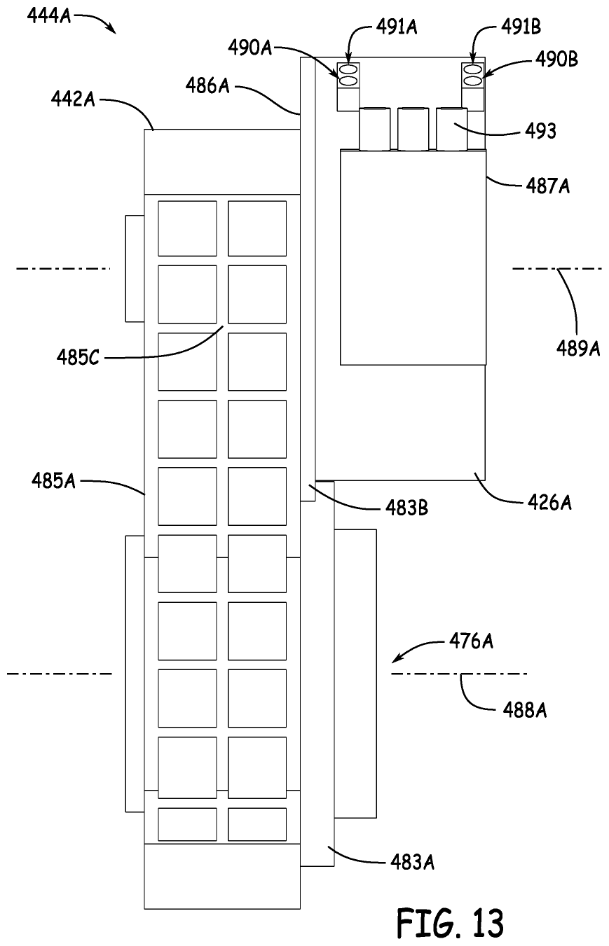

Referring specifically to FIG. 8, the first motor sub-assembly 444A of the power machine 400 includes a first drive motor 426A (i.e., a first electric motor), a first reduction assembly 442A, and a first bearing carrier 448A. In particular, an outboard side 482A of the first bearing carrier 448A is fixedly attached to the first side 462 of the frame 410 so that the first bearing carrier 448A is operably supported by the first side 462. A first attachment portion 483A (see FIGS. 11 and 13) of an outboard side 485A of the first reduction assembly 442A, opposite an inboard side 484A of the first reduction assembly 442A, is removably attached to an inboard side 481A of the first bearing carrier 448A so that the first reduction assembly 442A is operably supported by the first bearing carrier 448A relative to the frame 410, with the first reduction assembly 442A inboard of the first bearing carrier 448A. An inboard side 486A of the first drive motor 426A, opposite an outboard side 487A, is removably attached to a second attachment portion 483B (see FIGS. 11 and 13) of the outboard side 485A of the first reduction assembly 442A so that the first drive motor 426A is operably supported by the first reduction assembly 442A relative to the first bearing carrier 448A, and thereby relative to the frame 410, with the first drive motor 426A outboard of the first reduction assembly 442A and inboard of the first axle assembly 446A (e.g., spaced inboard apart therefrom).

As also shown in FIG. 8, a similar arrangement can be used for the second motor sub-assembly 444B of the power machine 400. For example, the motor sub-assembly 444B can include a second drive motor 426B (i.e., a second electric motor), a second reduction assembly 442B, and a second bearing carrier 448A, with inboard and outboard sides 484B, 485B, 486B, 487B of the second drive motor 426B and the second reduction assembly 442B similarly arranged (and numbered) as described above. As further discussed below, the motor sub-assemblies 444A, 444B can be arranged within the frame cavity 460 such that a gap 494 is defined between the motor sub-assemblies 444A, 444B (e.g., similar to the gap 394 in FIG. 6).

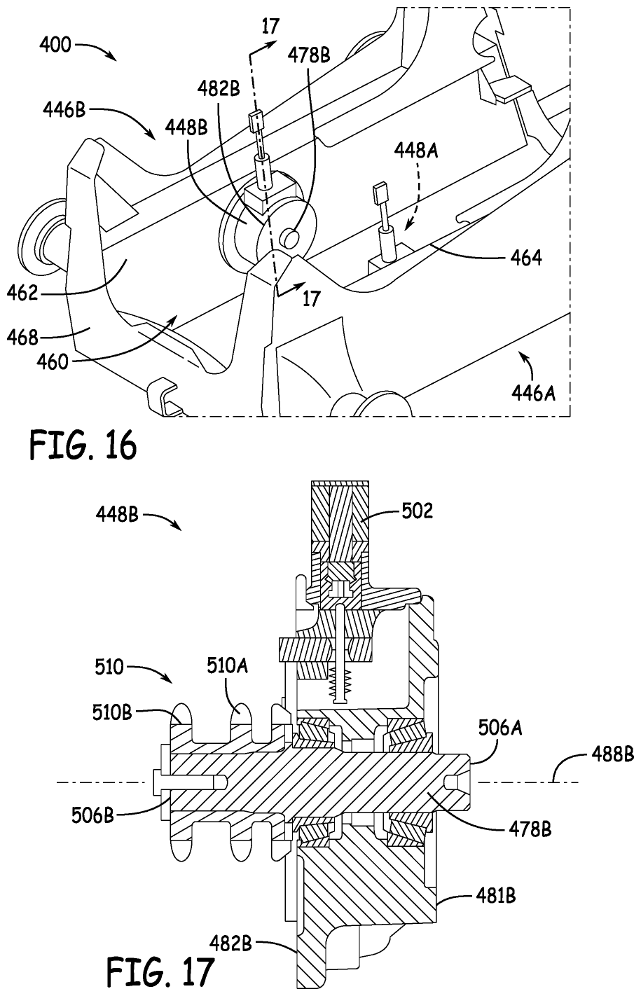

With continued reference to FIG. 8, first and second power transmission axes 488A, 448B are defined by corresponding shafts (see, e.g., first and second shafts 478A, 478B of bearing carriers 448A, 448B in FIG. 16) for transmission of power from the reduction assemblies 442A, 442B through the corresponding bearing carrier 448A, 448B to the corresponding axle assembly 446A, 446B. The drive motors 426A, 426B have associated drive axes 489A, 489B defined by the rotational axis of the respective motor 426A, 426B (see also FIGS. 11-13).

In some examples, power transmission, drive, or other axes of a motor sub-assembly can be aligned (e.g., horizontally or otherwise) with each other or other components. For example, in the illustrated configuration of the power machine 400, the motor sub-assemblies 444A, 444B are similarly configured and installed, but generally mirrored about the front to back direction 499 (as installed, see FIG. 7) to be laterally symmetric. Thus, the particular arrangement of the respective drive motors 426A, 426B, the reduction assemblies 442A, 442B, and the bearing carriers 448A, 448B of the motor sub-assemblies 444A, 444B are generally similar. For example, the first and second drive motors 426A, 426B are supported by the first and second reduction assemblies 442A, 442B, respectively, with the first and second drive axes 489A, 489B of the first and second drive motors 426A, 426B rearward of the respective first and second power transmission axes 488A, 488B of the first and second bearing carriers 448A, 448B. Further, the first and second drive axes 489A, 489B are horizontally aligned with the respective first and second power transmission axes 488A, 488B, along the front to back direction 499 (i.e., a front to back direction of the power machine 400). In other words, the first and second drive axes 489A, 489B both extend within a common horizontal plane with the first and second power transmission axes 488A, 488B. Still further, the first and second drive axes 489A, 489B are parallel with the respective first and second power transmission axes 488A, 488B. In other examples, however, other arrangements are possible for some or all of the noted axis alignments (or others).

In some examples, power transmission, drive, or other axes of a first motor sub-assembly can be aligned (e.g., coaxial) with corresponding axes of an opposed second motor sub-assembly. Referring still to FIG. 8, for example, the first power transmission axis 488A of the first bearing carrier 448A is aligned with the second power transmission axis 488B of the second bearing carrier 448B, relative to the front to back direction 499 (see FIG. 7). In other words, the first power transmission axis 488A is at the same front-to-back location as the second power transmission axis 488B. Further, the first drive axis 489A of the first drive motor 426A is aligned with the second drive axis 489B of the second drive motor 426B along the front to back direction 499. Still further, the first drive axis 489A of the first drive motor 426A is horizontally aligned with the first power transmission axis 488A of the first bearing carrier 448A, and the second drive axis 489B of the second drive motor 426B is horizontally aligned with the second power transmission axis 488B of the second bearing carrier 448B. Correspondingly, in some examples, the first drive axis 489A can be coaxial with the second drive axis 489B and the first power transmission axis 488A can be coaxial with the second power transmission axis 488B.

In other examples, however, other arrangements are possible for one or more drive motors, reduction assemblies, or bearing carriers of one or more motor sub-assemblies. For example, in some implementations, the first drive axis 489A of the first drive motor 426A can be offset rearward (or forward) from the second drive axis 489B of the second drive motor 426B, relative to the front to back direction 499. In some such examples, the first drive axis 489A of the first drive motor 426A can be arranged forward of the first power transmission axis 488A of the first bearing carrier 448A. Similarly, for example the second drive axis 489B of the second drive motor 426B can be arranged rearward of the second power transmission axis 488B of the second bearing carrier 448B. In some such cases, the power transmission axes 488A, 488B may still remain coaxial with each other. In some examples, a drive axis can be above or below a power transmission axis (e.g., with the drive and power transmission axes of a respective motor sub-assembly aligned vertically). In some such examples, the drive axes and power transmission axes can also be variously coaxially aligned with each other (e.g., having first and second drive axes coaxially aligned with each other, or first and second power transmission axes coaxially aligned with each other).

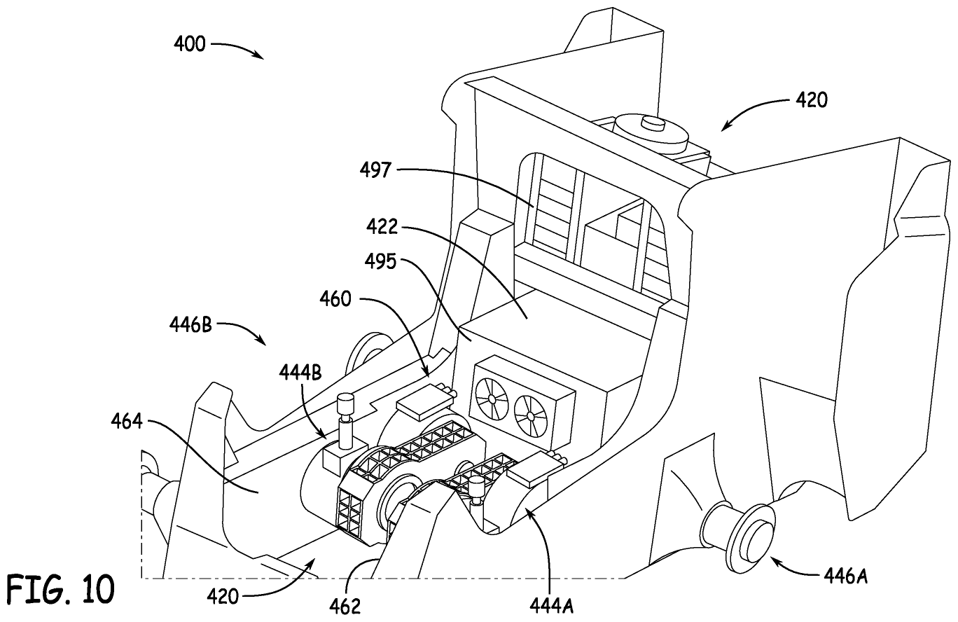

Referring specifically to FIGS. 9 and 10, the arrangement of the motor sub-assemblies 444A, 444B of the power machine 400 within the frame cavity 460 can provide additional space in the frame cavity 460 in comparison to conventional power system arrangements of other power machines. Notably, this arrangement can be particularly beneficial for power machines having power systems that utilize a rechargeable battery as a power source of the power system (i.e., the power source 422), which can require a substantially sized battery or a bank of numerous rechargeable batteries to provide adequate charge capacity. As shown in FIGS. 9 and 10, for example, the power source 422 of the power system 420 of the power machine 400 is arranged within a rearward portion (i.e., toward the rear side 466 of the frame 410) of the frame cavity 460. In particular, the arrangement of the motor sub-assemblies 444A, 444B in a frontward portion (i.e., toward the front side 468 of the frame 410) of the frame cavity 460 can provide more available space within the frame 410 so that the size and placement of the power source 422 can be optimized. Further, this arrangement can also provide adequate space for a battery management system 495 of the power machine 400 (e.g., arranged between the second side 464 of the frame 410 and the power source 422) and an electronic control system 497 of the power machine 400 (e.g., arranged directly above the power source 422).

The first drive motor 426A and the first reduction assembly 442A of the first motor sub-assembly 444A are shown in greater detail in FIGS. 11-13. Generally, a wide range of types of reduction assemblies and motors can be used, including non-electric (e.g., hydraulic) motors in some cases. In some examples, the reduction assemblies 442A, 442B can be a gearbox configured to provide a speed reduction for power transmission between the respective drive motors 426A, 426B and bearing carriers 438A, 438B. As illustrated, for example, the reduction assemblies 442A, 442B are parallel axis speed-reduction gearboxes with internal meshed gears (not shown). In other examples, belt transmissions, other gearboxes, or other known internal components for reduction assemblies can be used (e.g., with lateral spacing and relative placement of components still generally implemented according to the principles discussed herein). In some examples, a gearbox can be a right-angle gearbox or other gearbox with non-parallel input and output rotational axes.

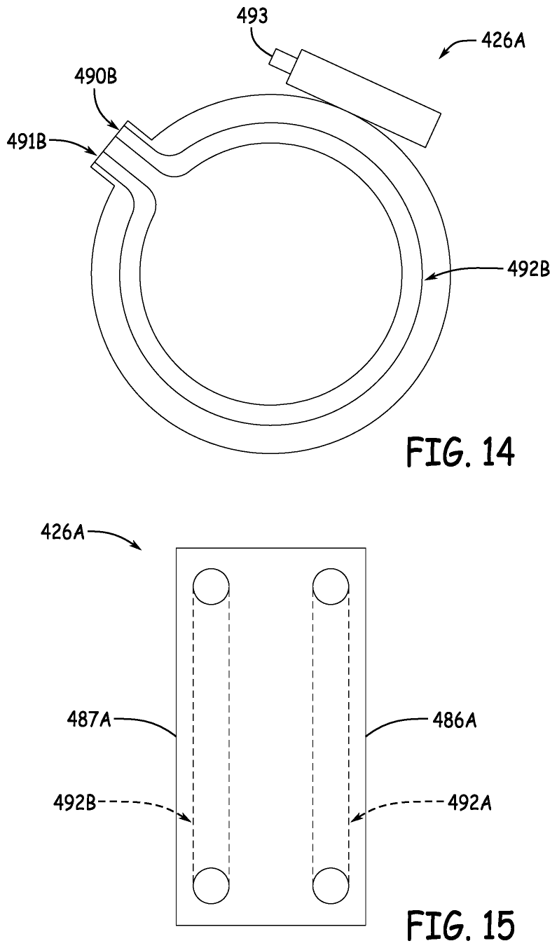

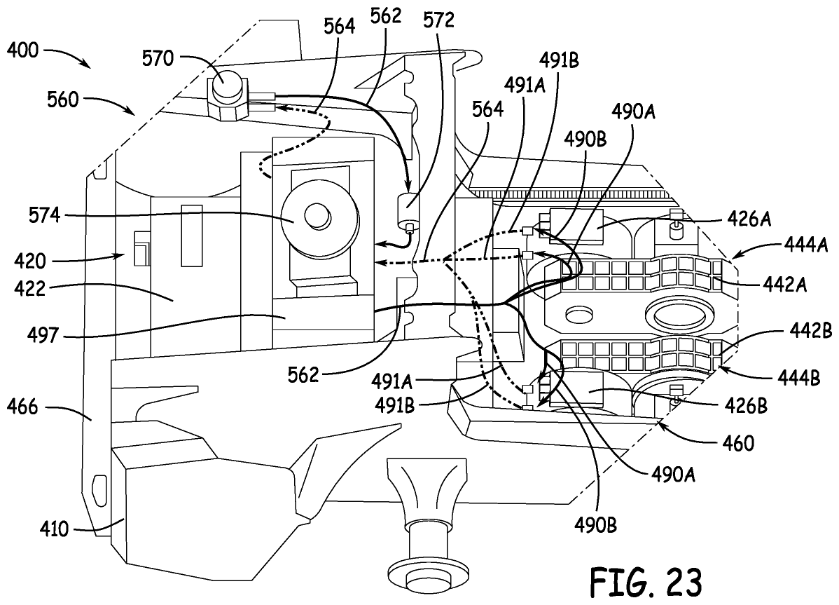

Generally, the first and second drive motors 426A, 426B can include one or more coolant inlets and one or more coolant outlets that can be configured to be in communication with a coolant system (such as, e.g., a cooling system 560 of FIG. 23) of the power machine 400. In the illustrated example, referring also to FIGS. 13-15, the first drive motor 426A includes a first coolant inlet 490A, a first coolant outlet 491A, a second coolant inlet 490B, and a second coolant outlet 491B, although different numbers or configurations are possible. The drive motors 426A, 426B can also include one or more internal cooling loops that can facilitate flow of coolant through the drive motors 426A, 426B to reduce or maintain temperature during continued operation of the power machine 400. For example, referring specifically to FIGS. 14 and 15, the first drive motor 426A includes parallel cooling loops 492A, 492B arranged toward the inboard and outboard sides 486A, 487A of the first drive motor 426A, respectively, and in communication with the first coolant inlet and outlet 490A, 491A and with the second coolant inlet and outlet 490B, 491B, respectively. In other examples, however, other cooling systems for motors are also possible.

In particular, according to some examples of the disclosed technology, coolant inlets or outlets of motor sub-assemblies can be oriented favorably for overall cooling efficiency, as well as other benefits. As shown particularly in FIG. 11, for example, the first coolant inlet and outlet 490A, 491A and the second coolant inlet and outlet 490B, 491B are disposed below a top surface 485C of the first reduction assembly 442A when the first drive motor 426A is attached to the first reduction assembly 442A. This particular configuration of the coolant inlets and outlets 490A, 490B, 491A, 491B of the first drive motor 426A can help shield one or more hoses attached to the coolant inlets and outlets 490A, 490B, 491A, 491B from being disconnected or otherwise adversely affected by work or maintenance operations with the power machine 400.

In some examples, the disclosed arrangement can also beneficially align the coolant inlets and outlets 490A, 490B, 491A, 491B to be more in line with the front to back direction 499 (see FIG. 7) to provide more efficient coolant flow. In particular, as shown in FIGS. 13 and 14, the exemplary configuration of the coolant inlets and outlets 490A, 490B, 491A, 491B of the first drive motor 426A can also align the coolant inlets and outlets 490A, 490B, 491A, 491B with one or more electrical connectors 493 of the first drive motor 426A, with each of these components facing generally toward the rear side 466 of the frame 410. Thus, as further described below, the coolant inlets and outlets 490A, 490B, 491A, 491B in particular can be oriented for efficient operation of a cooling system.

An example configuration of the second bearing carrier 448B and the second axle assembly 446B of the power machine 400 are shown in greater detail in FIGS. 16-19. In the illustrated example, the first bearing carrier 448A and the first axle assembly 446A are generally similar to the second bearing carrier 448B and the second axle assembly 446B, but mirrored about a central axis of the frame 410. For example, the second bearing carrier 448B can include a second shaft 478B just as the first bearing carrier 448A can include a first shaft 478A (see FIG. 16). Thus, in the illustrated example, the first and second bearing carriers 448A, 448B are aligned along the front to back direction 499 (see FIG. 7), with both bearing carriers 448A, 448B arranged closer to the front side 468 of the frame 410 than the rear side 466 (see FIGS. 7 and 8). In other examples, the bearing carriers 448A, 448B can have differing configurations or can be located at differing distances relative to the front side 468 of the frame 410 or the respective drive axles.

Referring specifically to FIG. 17, the second bearing carrier 448B of the second motor sub-assembly 444B includes the second shaft 478B and a brake system 502 configured to operatively engage the second shaft 478B to reduce or cease rotation of the second shaft 478B (and thus also the third and fourth axles 428C, 428D engaged with the second shaft 478B). In the illustrated example, a first (or inboard) end 506A of the second shaft 478B extends laterally inward from the inboard side 481B of the second bearing carrier 448B and is configured to be received within a second tube (e.g., the second tube 376B in FIG. 6 or similar to the first tube 476A of the first reduction assembly 442A in FIGS. 11 and 13) of the second reduction assembly 442B (see FIG. 8). A second (or outboard) end 506B of the second shaft 478B extends laterally outward from the outboard side 482B of the second bearing carrier 448B, into the axle assembly 446B.

With continued reference to FIG. 17, a sprocket assembly 510 including a first sprocket 510A and a second sprocket 510B is arranged on the second shaft 478B between the second end 506B and the outboard side 482B of the second bearing carrier 448B. In the illustrated example, the second sprocket 510B is arranged more toward the second end 506B of the second shaft 478B than the first sprocket 510A. Thus, rotation of the second shaft 478B, as powered by the second drive motor 426B, can power the two axles 428C, 428D via a two-chain drive. In other examples, however, differently configured shafts can permit bearing carriers to power differently configured axle assemblies.

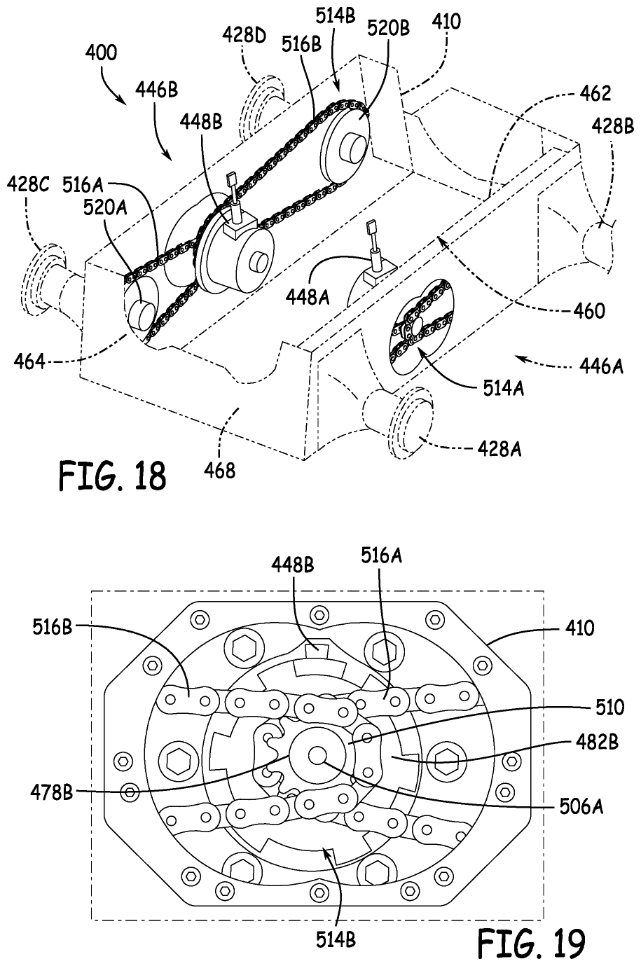

Generally, the axle assemblies 446A, 446B can have various configurations that operatively engage the bearing carriers 448A, 448B and drive the axles 428A, 428B, 428C, 428D, including with various known configurations for power transmission from a bearing carrier to one or more axles. Referring specifically to FIG. 18, in the illustrated example, the first axle assembly 446A includes a first chain case 514A that is configured to be operatively engaged by (and to operably support) the first bearing carrier 448A of the first motor sub-assembly 444A to drive rotation of the first and second axles 428A, 428B. Likewise, the second axle assembly 446B includes a second chain case 514B that is configured to be operatively engaged by (and to operably support) the second bearing carrier 448B of the second motor sub-assembly 444B to power rotation of the third and fourth axles 428C, 428D. In the illustrated example, the first and second chain cases 514A, 514B are enclosed within the first and second sides 462, 464, respectively, of the frame 410. The chain cases 514A, 514B can be similarly configured in some examples, so discussion of one of the chain cases 514A, 514B herein generally also applies to the other chain case 514B, 514A. However, in other examples, various other configurations are possible including with different axle assemblies on one or both sides of the power machine.

In the illustrated configuration, as also alluded to above, the chain cases 514A, 514B are configured to transmit power from the bearing carriers 448A, 448B, respectively, to separate axles using separate chains. For example, referring still to FIG. 18, the second chain case 514B of the second axle assembly 446B includes a first drive chain 516A and a second drive chain 516B that are each operatively engaged with the second shaft 478B of the second bearing carrier 448B. The first drive chain 516A is configured to rotationally engage a first axle gear 520A of the third axle 428C, and the second drive chain 516B is configured to rotationally engage a second axle gear 520B of the fourth axle 428D. As particularly shown in FIG. 19, the first drive chain 516A of the second axle assembly 446B is configured to rotationally engage the first spoke 510A (see FIG. 17) of the second shaft 478B of the second bearing carrier 448B, and the second drive chain 516B of the second axle assembly 446B is configured to rotationally engage the second spoke 510B (see FIG. 17) of the second shaft 478B of the second bearing carrier 448B. In other words, in the illustrated example, the first and second drive chains 516A, 516B of the second chain case 514B are driven simultaneously by rotation of the second shaft 478B of the second bearing carrier 448B to simultaneously power forward and rear ground engaging elements (e.g., tractive elements similar to the wheels 219A, 219B of the loader 200 in FIG. 3)

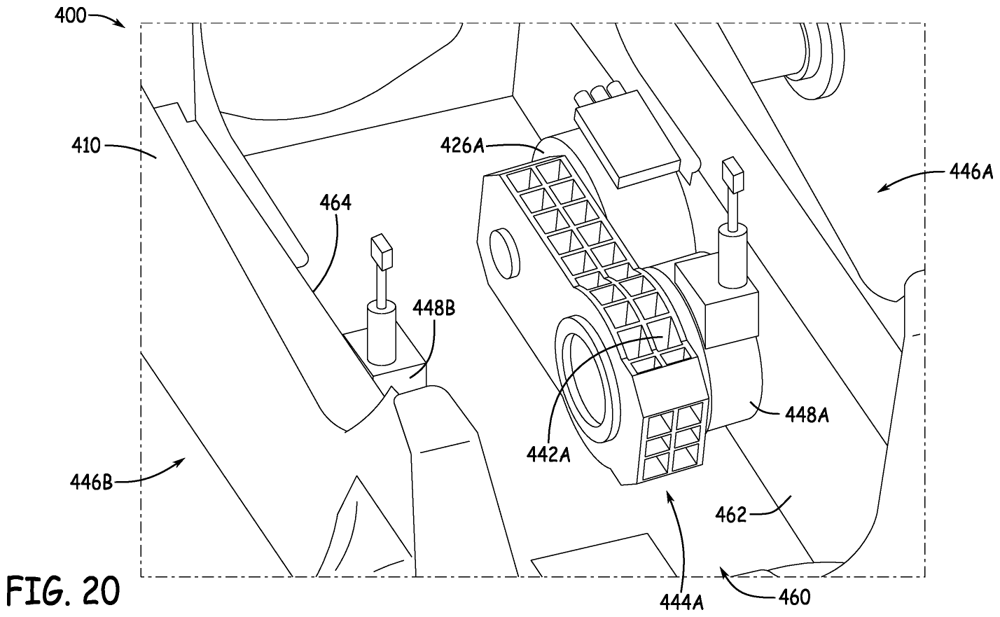

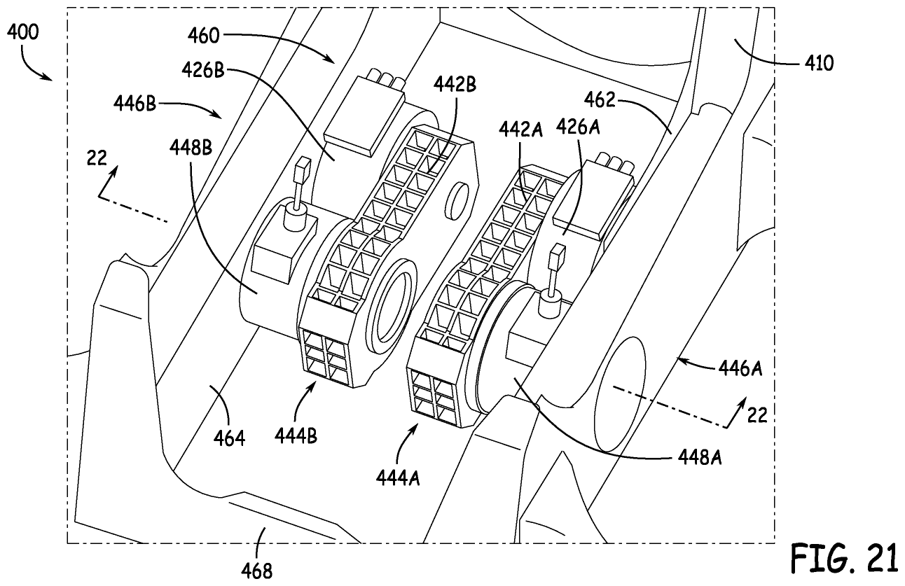

The motor sub-assemblies 444A, 444B can generally exhibit lateral spacing and widths as discussed relative to FIG. 6 and can thus be installed or removed from the frame 410 independently of each other, including with the other sub-assembly 444B, 444A already installed on the frame 410 (such as, e.g., via the defined gap 494 (see FIG. 6) between the motor sub-assemblies 444A, 444). In some cases, such operations can include separately installing or removing the reduction assemblies 442A, 442B and the drive motors 426A, 426B, but not the bearing carriers 448A, 448B (as shown in FIG. 16). In such cases the first or second reduction assemblies 442A, 442B (e.g., along with the attached first or second drive motors 426A, 426B) can be readily attached to or removed from the respective first or second bearing carriers 448A, 448B. For example, as shown in FIG. 20, the first motor sub-assembly 444A is in a fully installed configuration while only the second bearing carrier 448B of the second motor sub-assembly 444B is attached to the frame 410. With the first motor sub-assembly 444A remaining in the installed configuration, the second reduction assembly 442B (along with the second drive motor 426B attached thereto) can be removably attached to the previously installed second bearing carrier 448B so that the second motor sub-assembly 444A is in a fully installed configuration (as shown in FIG. 21).

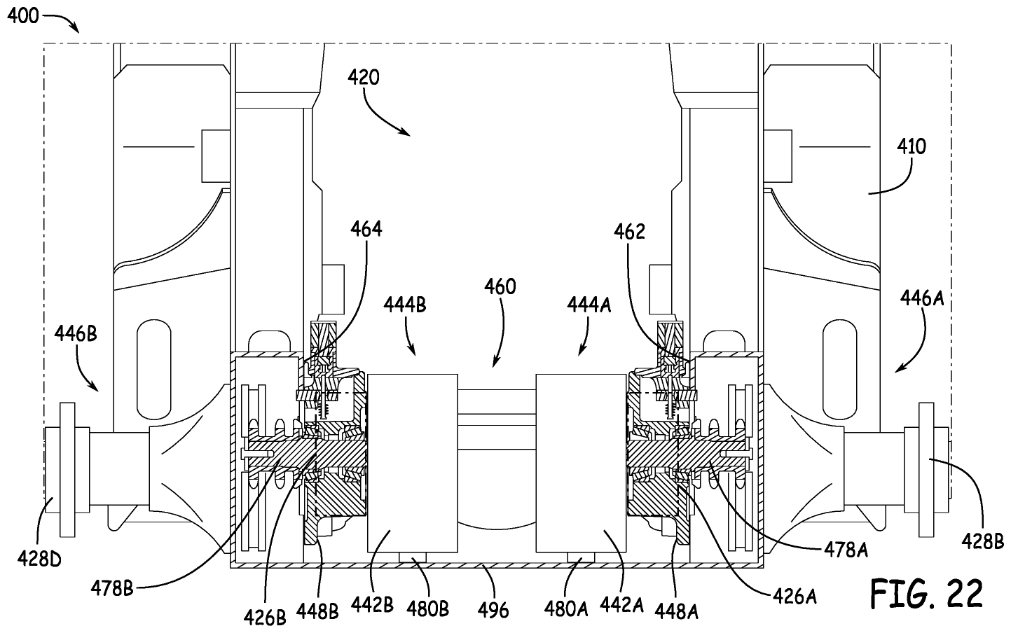

Referring specifically to FIG. 22, with the first and second motor sub-assemblies 444A, 444B both in the installed configuration (as shown in FIGS. 21 and 22), the first drive motor 426A is cantilevered from the first reduction assembly 442A and the first reduction assembly 442A is cantilevered from the first bearing carrier 448A (see also FIG. 7). Likewise, the second drive motor 426B is cantilevered from the second reduction assembly 442B and the second reduction assembly 442B is cantilevered from the second bearing carrier 448B. In other words, the first and second drive motors 426A, 426B are operably supported relative to the frame 410 only by the first and second bearing carriers 448A, 448B, via the first and second reduction assemblies 442A, 442B, respectively.

In some examples, the first and second reduction assemblies 442A, 442B may be operably supported by the frame 410 only via the first and second bearing carriers 448A, 448B, such that the first and second drive motors 426A, 426B are operably supported relative to the frame 410 only by the first and second bearing carriers 448A, 448B (via the first and second reduction assemblies 442A, 442B, respectively). In some examples, the first and second reduction assemblies 442A, 442B can be supported by the frame other than via the bearing carriers 448A, 448B (e.g., can also be attached to a bottom surface 496 of the frame cavity 460 via first and second tabs 480A, 480B, respectively).

As also noted above, some example motor sub-assemblies can be installed to provide improved cooling, including by orienting cooling inlets and outlets of a motor in a rearward direction. Referring now to FIG. 23, the power machine 400 can further include the cooling system 560, configured to facilitate flow of coolant through various components of the power system 420 and of the power machine 400 in general. In general, the cooling system 560 can provide a first (cooling) flow path 562 for flow of coolant (e.g., water) to components to be cooled, and a second (return) flow path 564 for flow of coolant from those components. In the illustrated example, the cooling system 560 includes a reservoir 570 configured to hold coolant, a pump 572 configured to pump coolant from the reservoir 570 along the cooling flow path 562, and a heat exchanger (e.g., a radiator 574) disposed along the return flow path 564 to dissipate heat from the coolant before the coolant returns to the reservoir 570. In other examples, other configurations are possible, including configurations with other generally known cooling components or arrangements substituted for or added to the components illustrated.

With continued reference to FIG. 23, in the illustrated example, the cooling flow path 562 of the cooling system 560 extends from the pump 572 to cool the electronic control system 497 of the power machine 400 (e.g., including inverters or other control devices for the drive motors 426A, 426B), and then continues to the drive motors 426A, 426B of the motor sub-assemblies 444A, 444B. More specifically, the cooling flow path 562 extends to the first and second coolant inlets 490A, 490B of the first and second cooling loops 492A, 492B of the drive motors 426A, 426B, respectively. After cooling the drive motors 426A, 426B, the coolant flows along the return flow path 564 that extends from the first and second coolant outlets 491A, 491B of the drive motors 426A, 426B to the radiator 574 and then to the reservoir 570.

With continued reference to FIG. 23, the cooling flow path 562 beneficially flows through the electronic control system 497 of the power machine 400 before the drive motors 426A, 426B. In particular, the drive motors 426A, 426B are likely to impose a significantly higher cooling load on the cooling system 560 than the electronic control system 497 during active operation of the power machine 400. Thus, the coolant flowing along the cooling flow path 562 may more effectively reduce the temperature of the electronic control system 497 than would an alternate coolant flow in a reversed direction or order (e.g., flow first to the drive motors 426A, 426B, followed by the electronic control system 497). In some examples, the rearward orientation of the coolant inlets and outlets 490A, 490B, 491A, 491B in particular can facilitate efficient routing and powering of coolant in this regard.

In some implementations, devices or systems disclosed herein can be utilized or configured for operation using methods embodying aspects of the present disclosure.

Correspondingly, description herein of particular features, capabilities, or intended purposes of a device or system is generally intended to inherently include disclosure of a method of using such features for the intended purposes, a method of implementing such capabilities, and a method of configuring disclosed (or otherwise known) components to support these purposes or capabilities. Similarly, unless otherwise indicated or limited, discussion herein of any method of manufacturing or using a particular device or system, including configuring the device or system for operation, is intended to inherently include disclosure, as examples of the disclosed technology, of the utilized features and implemented capabilities of such device or system.

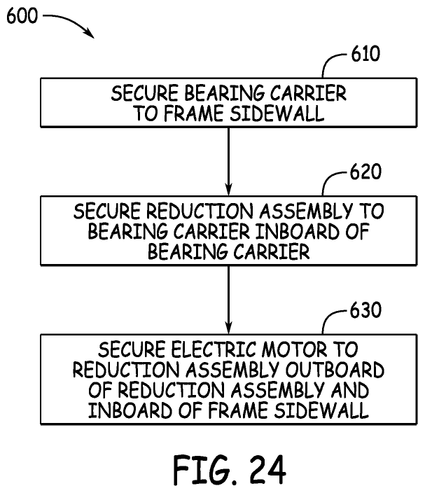

In this regard, some examples of the present disclosure can include a method for installing or otherwise servicing one or more motor sub-assemblies of a power system of a power machine. As one example, FIG. 24 illustrates a method 600 for assembling a power machine, as can be implemented, for example, on the power machines 300, 400 with the power systems 320, 420 illustrated in FIGS. 5-23.

Method 600 can generally include securing a motor sub-assembly on a corresponding lateral side of the power machine, to power one or more tractive elements on that lateral side. Accordingly, for example, the method 600 can include (at block 610) securing a bearing carrier to a frame sidewall on a lateral side of the power machine. Continuing, the method 600 can further include (at block 620) securing a reduction assembly to be inboard of the bearing carrier and the frame sidewall. For example, with a bearing carrier secured to a frame sidewall, operations at block 620 can include securing a gearbox or other reduction assembly to be cantilevered inboard from the bearing carrier, with the bearing carrier secured to the frame sidewall (e.g., via operations at block 610). Operations at block 630 of method 600 can then further include securing an electric motor outboard from the reduction assembly and inboard of the frame sidewall. For example, operations at block 630 can include securing a motor to be cantilevered outboard from a reduction assembly.

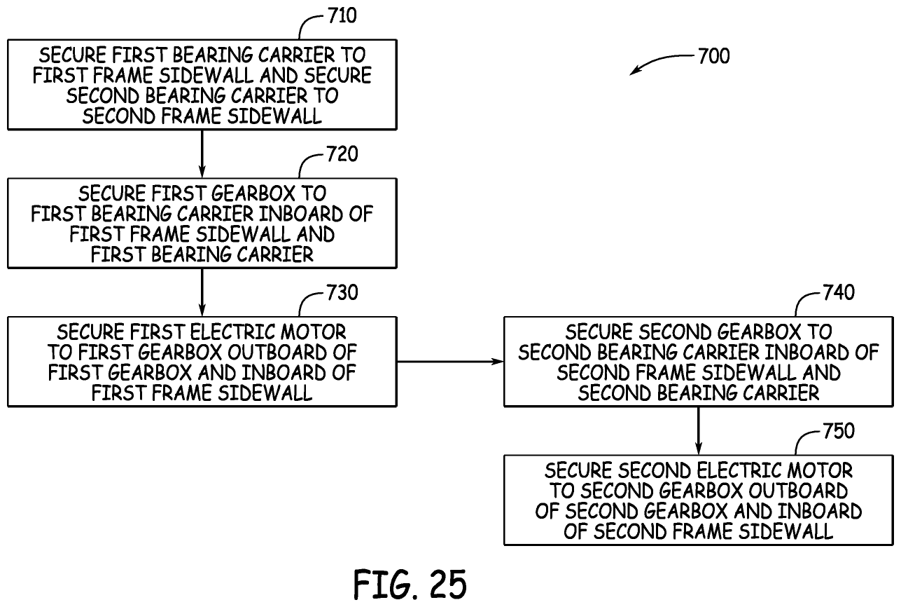

As also noted generally below, the operations illustrated in FIGS. 24 and 25 are not necessarily in temporal order. Correspondingly, for example, an electric motor can sometimes be secured to a reduction assembly (e.g., at block 630) before the reduction assembly is secured to a bearing carrier (e.g., at block 620). Similarly, in some cases, a reduction assembly can be secured to a bearing carrier (e.g., at block 620) before the bearing carrier is secured to a frame sidewall (e.g., at block 610).

FIG. 25 illustrates another exemplary method 700 for assembling a power machine, which can in some cases be implemented as a specific example of the method 600 (see FIG. 24). Generally, the method 700 can include securing a first motor sub-assembly on a first lateral side of the power machine to power one or more first tractive elements on the first lateral side and a second motor sub-assembly on a second lateral side of the power machine, opposite the first lateral side, to power one or more second tractive elements on the second lateral side. Accordingly, at block 710, the method 700 can include securing a first bearing carrier to a first frame sidewall on the first lateral side of the power machine and a second bearing carrier to a second frame sidewall on the second lateral side of the power machine.

Block 720 of method 700 can include securing a first gearbox to be cantilevered from the first bearing carrier with the first gearbox inboard of the first bearing carrier and the first frame sidewall. For example, a first gearbox can be secured to a first bearing carrier that has already been secured to the frame at block 710. Further, block 730 of method 700 can include securing a first electric motor to be cantilevered from the first gearbox with the first electric motor outboard of the first gearbox and inboard of the first frame sidewall. For example, a first electric motor can be secured to a first gearbox before (or after) the first gearbox is secured to a first bearing carrier at block 720 or after (or before) the first bearing carrier is secured to a first frame sidewall at block 710.

As shown at blocks 740 and 750, method 700 can further include, respectively, securing a second gearbox cantilevered from the second bearing carrier with the second gearbox inboard of the second bearing carrier and the second frame sidewall, or securing a second electric motor cantilevered from the second gearbox with the second electric motor outboard of the second gearbox and inboard of the second frame sidewall. In some examples, operations of either of the blocks 740, 750 can be executed after operations at blocks 710, 720 730 (e.g., after a first electric motor, a first gearbox, and a first bearing carrier of a first motor sub-assembly have been installed on a frame), so that the first and second electric motors can be independently installed (or removed) to provide drive power at opposed lateral sides of a power machine. Further, as similarly discussed relative to blocks 710, 720, 730, operations at blocks 710, 740, 750 can be executed in other orders than shown in FIG. 25.

Certain operations of methods according to the present disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular implementations of the present disclosure. Further, in some examples, certain operations can be executed in parallel.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

As used herein in the context of a power machine, unless otherwise defined or limited, the term “lateral” refers to a direction that extends at least partly to a left or a right side of a front-to-back reference line defined by the power machine. Accordingly, for example, a lateral sidewall of a cab of a power machine can be a left sidewall or a right sidewall of the cab, relative to a frame of reference of an operator who is within the cab or is otherwise oriented to operatively engage with controls of an operator station of the cab. Similarly, a “centerline” of a power machine refers to a reference line that extends in a front-to-back direction of a power machine, approximately half-way between opposing lateral sides of an outer spatial envelope of the power machine.

Also as used herein, unless otherwise defined or limited, the terms “inboard” and “outboard” indicate a relative relationship (e.g., a lateral distance) between one or more objects or structures and a centerline of the power machine, along a lateral side of the power machine. For example, a first structure that is inboard of a second structure is positioned laterally inward from the second structure so that a distance between the first structure and the centerline of the power machine is less than a distance between the second structure and the centerline of the power machine. Conversely, a first structure that is outboard of second structure is positioned laterally outward from the second structure so that a distance between the first structure and the centerline of the power machine is greater than a distance between the second structure and the centerline of the power machine.

Similarly, as used herein, unless otherwise defined or limited, the terms “interior” and “exterior” refers to a relative relationship (e.g., a lateral distance) between one or more structures (e.g., a sub-structure) and a centerline of a reference structure (e.g., a main structure) that extends in a front-to-back direction or between first and second ends of the reference structure. For example, an interior structure is disposed closer to a centerline of a reference structure than an exterior structure. In this regard, an outboard structure of a subassembly of a power machine may also be an exterior structure, but an exterior structure of a subassembly, relative to a centerline of the subassembly, may not necessarily be outboard of other components of the subassembly.

Unless otherwise defined or limited, two components that are described herein as “substantially aligned” are aligned along a particular reference direction (e.g., a front-to-back direction (such as the front to back direction 499 of the frame 410 of the power machine 400 in FIG. 7)) across more than half of a dimension of at least one the components in a direction orthogonal to the reference direction.

Also as used herein, unless otherwise limited or defined, “substantially parallel” indicates a direction that is within ±12 degrees of a reference direction (e.g., within ±6 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction. Similarly, as used herein, unless otherwise limited or defined, “substantially perpendicular” indicates a direction that is within ±12 degrees of perpendicular a reference direction (e.g., within ±6 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

Also as used herein, unless otherwise limited or defined, “operably supported” refers to two components that are moveably engaged together to transmit power. Similarly, “operably engaged” indicates that a first component and a second components are connected together so that the first component provides structural support to the second, relative to the first component or another structure.

Although the presently disclosed technology has been described with reference to preferred implementations, workers skilled in the art will recognize that changes may be made in form and detail without departing from the scope of the discussion.

What is claimed is:

1. A power transmission assembly for a power machine that defines a lateral direction, the power transmission assembly comprising:
a first motor sub-assembly that includes:
a bearing carrier having an inboard side, and an outboard side configured to be fixedly attached to a first side of a frame of the power machine to operably transmit rotational power to at least one tractive element of the power machine;
a reduction assembly having an outboard side fixedly attached to the inboard side of the bearing carrier; and
an electric motor having an inboard side fixedly attached to the outboard side of the reduction assembly to operably transmit the rotational power to the bearing carrier via the reduction assembly, with the electric motor disposed laterally between the reduction assembly and the first side of the frame.

2. The power transmission assembly of claim 1, wherein, with the first motor sub-assembly secured to the frame of the power machine, the electric motor is supported by the reduction assembly with a drive axis of the electric motor rearward of a power transmission axis of the bearing carrier.

3. The power transmission assembly of claim 2, wherein, with the first motor sub-assembly secured to the frame of the power machine, the drive axis is one or more of:
horizontally aligned with the power transmission axis along a front to back direction of the power machine; or
parallel with the power transmission axis.

4. The power transmission assembly of claim 1, wherein the reduction assembly is a gearbox providing a speed reduction for power transmission between the electric motor and the bearing carrier.

5. The power transmission assembly of claim 1, wherein the outboard side of the bearing carrier of the first motor sub-assembly is secured to a first lateral side of the frame of the power machine; and
wherein the power transmission assembly further comprises a second motor sub-assembly that includes:
a second bearing carrier having an inboard side, and an outboard side fixedly attached to a second lateral side of the frame of the power machine to operably transmit rotational power to at least one second tractive element of the power machine;
a second reduction assembly having an outboard side fixedly attached to the inboard side of the second bearing carrier; and
a second electric motor having an inboard side fixedly attached to the outboard side of the second reduction assembly to operably transmit the rotational power to the second bearing carrier via the second reduction assembly, with the second electric motor disposed laterally between the second reduction assembly and the second lateral side of the frame.

6. The power transmission assembly of claim 5, wherein the first motor sub-assembly is secured to a first chain case on the first lateral side of the frame to power first and second axles of the power machine; and
wherein the second motor sub-assembly is secured to a second chain case on the second lateral side of the frame to power third and fourth axles of the power machine.

7. The power transmission assembly of claim 1, wherein, in an installed configuration on the power machine, the electric motor is cantilevered from the reduction assembly and the reduction assembly is cantilevered from the bearing carrier.

8. The power transmission assembly of claim 7, wherein the bearing carrier defines a first lateral width that corresponds to a first lateral spacing of the reduction assembly from the frame in the installed configuration, and the electric motor defines a second lateral width that is smaller than the first lateral spacing, so that the electric motor is spaced laterally from the frame in the installed configuration.

9. A power machine comprising:
a frame;
a power source supported by the frame;
a first axle assembly arranged on a first side of the frame; and
a first motor sub-assembly arranged along the first side of the frame to power the first axle assembly, the first motor sub-assembly including:
a first bearing carrier fixedly attached to and operably supported by the first side of the frame and operably engaged with the first axle assembly;
a first reduction assembly operably supported by the first bearing carrier relative to the frame, with the first reduction assembly inboard of the first bearing carrier and operably engaged with the first bearing carrier to power the first axle assembly via the first bearing carrier; and
a first electric motor operably supported by the first reduction assembly relative to the first bearing carrier, to be thereby supported by the first bearing carrier relative to the frame, with the first electric motor being: outboard of the first reduction assembly, inboard of the first axle assembly, and operably engaged with the first reduction assembly to power the first axle assembly via the first reduction assembly and the first bearing carrier, using power from the power source.

10. The power machine of claim 9, further comprising:
a second axle assembly arranged on a second side of the frame that is laterally opposite the first side; and
a second motor sub-assembly arranged along the second side of the frame to power the second axle assembly, the second motor sub-assembly including:
a second bearing carrier fixedly attached to the second side of the frame and operably engaged with the second axle assembly;
a second reduction assembly operably supported by the second bearing carrier relative to the frame, with the second reduction assembly inboard of the second bearing carrier and operably engaged with the second bearing carrier to power the second axle assembly via the second bearing carrier; and
a second electric motor operably supported by the second reduction assembly relative to the second bearing carrier, to be thereby supported by the second bearing carrier relative to the frame, with the second electric motor being: outboard of the second reduction assembly, inboard of the second axle assembly, and operably engaged with the second reduction assembly to power the second axle assembly via the second reduction assembly and second bearing carrier, using power from the power source.

11. The power machine of claim 10, wherein a power transmission axis of the first bearing carrier is aligned with a power transmission axis of the second bearing carrier, relative to a front to back direction of the power machine.

12. The power machine of claim 11, wherein a drive axis of the first electric motor is aligned with a drive axis of the second electric motor along the front to back direction.

13. The power machine of claim 12, wherein the drive axis of the first electric motor is horizontally aligned with the power transmission axis of the first bearing carrier, and the drive axis of the second electric motor is horizontally aligned with the power transmission axis of the second bearing carrier.

14. The power machine of claim 10, wherein a drive axis of the first electric motor is offset one of forward or rearward from a drive axis of the second electric motor, relative to a front to back direction of the power machine.

15. The power machine of claim 9, wherein the first electric motor is one or more of:
operably supported relative to the frame only by the first bearing carrier, via the first reduction assembly; or
operably supported relative to the frame only via the first reduction assembly.

16. The power machine of claim 10, wherein the first motor sub-assembly is secured within a frame cavity having a cavity width in a lateral direction; and
wherein the first reduction assembly is supported by the first bearing carrier to define an installed lateral width of the first motor sub-assembly that is in a range between 40% of the cavity width and 48% of the cavity width, inclusive.

17. The power machine of claim 9, wherein the first axle assembly includes a first chain case that powers a forward ground engaging element and a rearward ground engaging element.

18. The power machine of claim 9, wherein the first electric motor includes a cooling loop, and a coolant inlet and a coolant outlet that are in communication with the cooling loop; and
wherein, the first motor sub-assembly is secured to the frame of the power machine so that the first reduction assembly supports the first electric motor with the coolant inlet and the coolant outlet one or more of:
opening rearwardly, relative to a front to back direction of the power machine; or
being aligned below a top surface of the first reduction assembly.

19. A method of assembling a power machine, the method comprising:
securing a first motor sub-assembly on a first lateral side of the power machine, to power one or more first tractive elements on the first lateral side, including:
securing a first bearing carrier to a first frame sidewall on the first lateral side of the power machine;
securing a first gearbox to be cantilevered from the first bearing carrier with the first gearbox inboard of the first bearing carrier and the first frame sidewall; and
securing a first electric motor to be cantilevered from the first gearbox with the first electric motor outboard of the first gearbox and inboard of the first frame sidewall.

20. The method of claim 19, further comprising:
securing a second motor sub-assembly on a second lateral side of the power machine, opposite the first lateral side, to power one or more second tractive elements, including:
securing a second bearing carrier to a second frame sidewall on the second lateral side of the power machine; and
after securing the first gearbox and the first electric motor on the first lateral side of the power machine:
securing a second gearbox to be cantilevered from the second bearing carrier with the second gearbox inboard of the second bearing carrier and the second frame sidewall; and
securing a second electric motor to be cantilevered from the second gearbox with the second electric motor outboard of the second gearbox and inboard of the second frame sidewall.
